(19) United States
(12) Patent Application Publication
(10) Pub. No.: US 2025/0386240 A1
(43) Pub. Date: Dec. 18, 2025

(54) METHODS AND APPARATUSES FOR A PROTOCOL DATA UNIT (PDU) SET DELAY STATUS REPORT

(71) Applicant: Lenovo (Beijing) Limited, Beijing (CN)

(72) Inventors: Xiaoying Xu, Shanghai (CN); Mingzeng Dai, Shanghai (CN); Congchi Zhang, Shanghai (CN); Lianhai Wu, Beijing (CN)

(73) Assignee: Lenovo (Beijing) Limited, Beijing (CN)

(21) Appl. No.: 18/877,757

(22) PCT Filed: Jun. 23, 2022
(86) PCT No.: PCT/CN2022/100918

§ 371 Date: Dec. 20, 2024

(51) Int. Cl. H04W 28/02; H04L 69/322

(52) U.S. Cl. CPC H04W 28/0278; H04L 69/322

(57) ABSTRACT

Embodiments of the subject application relate to methods and apparatuses for a delay status report associated with a protocol data unit (PDU) set. According to an embodiment of the subject application, a user equipment (UE) includes a processor and a transceiver coupled to the processor, and the processor is configured to: determine delay information associated with one or more protocol data unit (PDU) sets received from an upper layer of the UE, wherein the delay information includes at least one of: a remaining PDU set delay budget; a PDU set buffer delay; a PDU set delay budget offset; or first timing when receiving a PDU within the one or more PDU sets from the upper layer; and transmit a report including the delay information, wherein the report is at least one of: a delay budget report (DBR); a delay report (DR); an arriving timing report (ATR); or an enhanced buffer status report (EBSR).

### TECHNICAL FIELD

Embodiments of the subject application generally relate to wireless communication technology, in particular to methods and apparatuses for a delay status report associated with a protocol data unit (PDU) set.

### BACKGROUND

Extended reality (XR), including augmented reality (AR) and virtual reality (VR), as well as cloud gaming (CG), presents a new promising category of connected devices, applications, and services. As a potential working area of 3GPP (3rd generation partnership project) Rel-18, application and traffic awareness in radio access network (RAN) is one of key feature to improve user experience of XR services. Currently, details regarding a delay status report associated with a PDU set (e.g., a frame) have not been discussed yet.

### SUMMARY

Some embodiments of the subject application also provide a user equipment (UE). The UE includes a processor and a transceiver coupled to the processor; and the processor is configured to: determine delay information associated with one or more protocol data unit (PDU) sets received from an upper layer of the UE, wherein the delay information includes at least one of: a remaining PDU set delay budget; a PDU set buffer delay; a PDU set delay budget offset; or first timing when receiving a PDU within the one or more PDU sets from the upper layer; and transmit a report including the delay information, wherein the report is at least one of: a delay budget report (DBR); a delay report (DR); an arriving timing report (ATR); or an enhanced buffer status report (EBSR).

In some embodiments, the delay information includes delay information associated with a first arrival PDU or a last arrival PDU of one PDU set within the one or more PDU sets. The arrival PDU may be named arrived PDU in this application.

In some embodiments, the remaining PDU set delay budget corresponds to one PDU set with a minimum delay budget within the one or more PDU sets; the PDU set buffer delay corresponds to one PDU set with a maximum buffer delay within the one or more PDU sets; or the first timing corresponds to one PDU set with earliest arriving timing within the one or more PDU sets.

In some embodiments, the delay information includes delay information corresponding to one PDU set within the one or more PDU sets with a highest priority logical channel allowed to report the delay information in an LCG or in a MAC entity of the UE or in the UE.

In some embodiments, the delay information includes at least one of: delay information corresponding to one PDU set within the one or more PDU sets with a logical channel with or without data available for transmission; or delay information corresponding to one PDU set within the one or more PDU sets in an LCG with or without data available for transmission.

In some embodiments, the delay information is determined according to at least one of: a PDU set delay budget; a packet delay budget; a PDU set delay budget timer; a PDU set discard timer; an SDU discard timer; a PDU set delay budget offset; reference time related to the PDU set; or the first timing.

In some embodiments, the one or more PDU sets are received by an access stratum (AS) layer of the UE, and wherein the first timing includes at least one of: arriving timing at the AS layer of a first arrival PDU within the one or more PDU sets from the upper layer; or arriving timing at the AS layer of a certain PDU within the one or more PDU sets from the upper layer; or arriving timing at the AS layer of a last arrival PDU within the one or more PDU sets from the upper layer.

In some embodiments, to determine the remaining PDU set delay budget, the processor of the UE is configured to: start the PDU set delay budget timer upon receiving a PDU within the PDU set from the upper layer; stop the PDU set delay budget timer at the reference time; and determine a remaining length value of the PDU set delay budget timer.

In some embodiments, the reference time is: timing of assembling a MAC PDU including the delay information into a medium access control (MAC) PDU; or timing of transmitting the report.

In some embodiments, the remaining PDU set delay budget is determined based on: a sum of the PDU set delay budget and the PDU set delay budget offset; or a sum of a remaining length value of the PDU set delay budget timer and the PDU set delay budget offset.

In some embodiments, the remaining PDU set delay budget is determined based on the PDU set delay budget, the first timing, and the reference time; the remaining PDU set delay budget is determined based on the PDU set delay budget offset, the PDU set delay budget, the first timing, and the reference time; or the PDU set buffer delay is determined based on the first timing and the reference time.

In some embodiments, the PDU set delay budget offset is received from the upper layer of the UE.

In some embodiments, the processor of the UE is configured to transmit an indication for indicating a capability of the UE for supporting a transmission of the report via the transceiver to the network.

In some embodiments, the processor of the UE is configured to receive a configuration related to the delay information via the transceiver from the network.

In some embodiments, the configuration includes at least one of: information for enabling a transmission of the report; a trigger threshold associated with the trigger condition; a cancel threshold associated with a cancel condition; the PDU set delay budget; a length of the PDU set delay budget timer; a length of a PDU set discard timer; a length of a SDU discard timer; a length of a periodic timer associated with the report; a length of a retransmission timer associated with the report.

In some embodiments, the configuration is associated with: an LCH allowed to report the delay information; an LCG allowed to report the delay information; a data radio bearer (DRB) allowed to report the delay information; or a MAC entity of the UE allowed to report the delay information.

In some embodiments, the report includes at least one of: information of a logical channel (LCH) corresponding to the delay information; information of a logical channel group (LCG) corresponding to the delay information; information of a data radio bearer (DRB) corresponding to the delay information; or information associated with the one or more PDU sets.

In some embodiments, the processor of the UE is configured to trigger the report based on a trigger condition.

In some embodiments, the trigger condition includes at least one of: upon receiving a first arrival PDU within the one or more PDU sets from the upper layer; upon receiving a PDU with an important indication within the one or more PDU sets from the upper layer; upon receiving a last arrival PDU within the one or more PDU sets from the upper layer; upon an expiry of a periodic timer associated with the report; upon an expiry of a retransmission timer associated with the report; upon the PDU set delay budget being less than or equal to a first trigger threshold associated with the trigger condition; upon the PDU set delay being greater than or equal to a second trigger threshold associated with the trigger condition; or upon a total number of padding bits of allocated uplink (UL) resources being greater than or equal to a bit size of a MAC sub-PDU including the report; or upon a request from the upper layer; or upon receiving a dynamic report request from a network.

In some embodiments, the report is transmitted in response to unfulfillment of a cancel condition.

In some embodiments, the processor of the UE is configured to cancel the report based on a cancel condition.

In some embodiments, the cancel condition includes at least one of: in case that the remaining PDU set delay budget is less than or equal to a first cancel threshold; in case that the PDU set delay is greater than or equal to a second cancel threshold; upon an expiry of a PDU set delay budget timer; upon an expiry of a SDU discard timer of a PDU within the PDU set; upon an expiry of a PDU set discard timer; upon transmitting a MAC PDU including the report, wherein the report is triggered prior to assembling the MAC PDU or at timing of assembling the MAC PDU; in case that padding bits of allocated uplink (UL) resources are not sufficient to accommodate the MAC PDU; or in case that the padding bits of the allocated UL resources are not sufficient to accommodate the MAC PDU, and that the report is triggered with a highest logical channel priority being less than or equal to a logical channel priority of all pending data available.

In some embodiments, a MAC sub-PDU including the report carries at least one of: one remaining PDU set delay budget related to a PDU set within the one or more PDU sets for one LCH; two or more remaining PDU set delay budgets related to two or more PDU sets within the one or more PDU sets for the one LCH; multiple remaining PDU set delay budgets related to multiple PDU sets within the one or more PDU sets for two or more LCHs; one remaining PDU set delay budget related to the one or more PDU sets for one LCG; two or more remaining PDU set delay budgets related to two or more PDU sets within the one or more PDU sets for the one LCG; multiple remaining PDU set delay budgets related to multiple PDU sets within the one or more PDU sets for two or more LCGs; a PDU set delay budget offset related to a PDU set within the one or more PDU sets for the one LCH or for the one LCG; or multiple remaining PDU set delay budget offsets related to multiple PDU sets within the one or more PDU sets for the two or more LCHs or for the two or more LCGs.

In some embodiments, in response to determining that the delay information includes one or more pieces of delay information for one or more LCHs or one or more LCGs, the processor of the UE is configured to prioritize the one or more pieces of delay information, and wherein the report includes all or a part of the prioritized one or more pieces of delay information.

In some embodiments, in response to padding bits of allocated uplink (UL) resources being not sufficient to accommodate one or more pieces of delay information included in the delay information for one or more LCHs or one or more LCGs, the processor of the UE is configured to: prioritize the one or more pieces of delay information in a decreasing order of priorities of the one or more LCHs; or prioritize the one or more pieces of delay information in a decreasing order of a highest priority logical channel in each of the one or more LCGs; or in case that the one or more pieces of delay information have an equal logical channel priority, prioritize the one or more pieces of delay information in an increasing order or a decreasing order of the value of the delay information, wherein the report includes a part of the prioritized one or more pieces of delay information.

In some embodiments, a priority of a first MAC control element (CE) of a first type of the report is greater than or equal to a priority of a second MAC CE for a first type of a BSR; the priority of the first MAC CE is less than or equal to the priority of the second MAC CE; a relation between the priority of the first MAC CE and the priority of the second MAC CE is depends upon the UE's implementation; a priority of a third MAC CE of a second type of the report is greater than or equal to a priority of a fourth MAC CE for a second type of the BSR; the priority of the third MAC CE is less than or equal to the priority of the fourth MAC CE; or a relation between the priority of the third MAC CE and the priority of the fourth MAC CE is depends upon the UE's implementation.

Some embodiments of the subject application also provide a network node (e.g., a base station (BS)). The network node includes a processor and a transceiver coupled to the processor; and the processor is configured to: transmit a configuration related to delay information associated with one or more protocol data unit (PDU) sets received from an upper layer of a user equipment (UE) via the transceiver to the UE; and receive a report including the delay information via the transceiver from the UE.

In some embodiments, the delay information includes at least one of: a remaining PDU set delay budget; a PDU set buffer delay; a PDU set delay budget offset; or first timing when receiving a PDU within the one or more PDU sets from the upper layer.

In some embodiments, the delay information includes delay information associated with a first arrival PDU or a last arrival PDU of one PDU set within the one or more PDU sets.

In some embodiments, the remaining PDU set delay budget corresponds to one PDU set with a minimum delay budget within the one or more PDU sets; the PDU set buffer delay corresponds to one PDU set with a maximum buffer delay within the one or more PDU sets; or the first timing corresponds to one PDU set with earliest arriving timing within the one or more PDU sets.

In some embodiments, the delay information includes delay information corresponding to one PDU set within the one or more PDU sets with a highest priority logical channel allowed to report the delay information in an LCG or in a MAC entity of the UE or in the UE.

In some embodiments, the delay information includes at least one of: delay information corresponding to one PDU set within the one or more PDU sets with a logical channel with or without data available for transmission; or delay information corresponding to one PDU set within the one or more PDU sets in an LCG with or without data available for transmission.

In some embodiments, the first timing includes at least one of: arriving timing at an access stratum (AS) layer of the UE of a first arrival PDU within the one or more PDU sets from the upper layer; or arriving timing at the AS layer of a certain PDU within the one or more PDU sets from the upper layer; or arriving timing at the AS layer of a last arrival PDU within the one or more PDU sets from the upper layer.

In some embodiments, the configuration includes at least one of: information for enabling a transmission of the report; a trigger threshold associated with a trigger condition of the report; a cancel threshold associated with a cancel condition of the report; a PDU set delay budget; a length of a PDU set delay budget timer; a length of a PDU set discard timer; a length of a SDU discard timer; a length of a periodic timer associated with the report; or a length of a retransmission timer associated with the report.

In some embodiments, the configuration is associated with: an LCH allowed to report the delay information; an LCG allowed to report the delay information; a DRB allowed to report the delay information; or a MAC entity of the UE allowed to report the delay information.

In some embodiments, the report is at least one of: a delay budget report (DBR); a delay report (DR); an arriving timing report (ATR); or an enhanced buffer status report (EBSR).

In some embodiments, the report includes at least one of: information of a logical channel (LCH) corresponding to the delay information; information of a logical channel group (LCG) corresponding to the delay information; information of a data radio bearer (DRB) corresponding to the delay information; or information associated with the one or more PDU sets.

In some embodiments, the report is included in a MAC sub-PDU, and the MAC sub-PDU includes at least one of: one remaining PDU set delay budget related to a PDU set within the one or more PDU sets for one LCH; two or more remaining PDU set delay budgets related to two or more PDU sets within the one or more PDU sets for the one LCH; multiple remaining PDU set delay budgets related to multiple PDU sets within the one or more PDU sets for two or more LCHs; one remaining PDU set delay budget related to the one or more PDU sets for one LCG; two or more remaining PDU set delay budgets related to two or more PDU sets within the one or more PDU sets for the one LCG; or multiple remaining PDU set delay budgets related to multiple PDU sets within the one or more PDU sets for two or more LCGs.

In some embodiments, the processor of the network node is configured to receive an indication for indicating a capability of the UE for supporting a transmission of the report via the transceiver from the UE.

Some embodiments of the subject application provide a method, which may be performed by a UE. The method includes: determining delay information associated with one or more protocol data unit (PDU) sets received from an upper layer of the UE, wherein the delay information includes at least one of: a remaining PDU set delay budget; a PDU set buffer delay; a PDU set delay budget offset; or first timing when receiving a PDU within the one or more PDU sets from the upper layer; and transmitting a report including the delay information, wherein the report is at least one of: a delay budget report (DBR); a delay report (DR); or an arriving timing report (ATR); or an enhanced buffer status report (EBSR).

Some embodiments of the subject application provide a method, which may be performed by a UE. The method includes: transmitting a configuration related to delay information associated with one or more protocol data unit (PDU) sets received from an upper layer of a user equipment (UE) to the UE; and receiving a report including the delay information from the UE.

Some embodiments of the subject application also provide an apparatus for wireless communications. The apparatus includes: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement any of the above-mentioned methods performed by a UE or a network node (e.g., a BS).

The details of one or more examples are set forth in the accompanying drawings and the descriptions below. Other features, objects, and advantages will be apparent from the descriptions and drawings, and from the claims.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1A illustrates a schematic diagram of a wireless communication system in accordance with some embodiments of the subject application.

FIG. 1B illustrates an exemplary schematic diagram of a PDU set delay budget of XR traffic in accordance with some embodiments of the subject application.

FIG. 2 illustrates an exemplary flowchart regarding delay information associated with a PDU set in accordance with some embodiments of the subject application.

FIG. 3 illustrates a further exemplary flowchart regarding delay information associated with a PDU set in accordance with some embodiments of the subject application.

FIG. 4 illustrates an exemplary flowchart of a configuration procedure for a delay status report in accordance with some embodiments of the subject application.

FIGS. 5A and 5B illustrate exemplary schematic diagrams of a PDU set delay budget of XR traffic in accordance with some embodiments of the subject application.

FIGS. 6A-6D illustrate exemplary MAC PDUs including a remaining delay budget in accordance with some embodiments of the subject application.

FIGS. 7A-7D illustrate exemplary MAC PDUs including a remaining PDU set delay budget in accordance with some embodiments of the subject application.

FIG. 8 illustrates an exemplary block diagram of an apparatus for a delay status report in accordance with some embodiments of the subject application.

FIG. 9 illustrates a further exemplary block diagram of an apparatus for a delay status report in accordance with some embodiments of the subject application.

### DETAILED DESCRIPTION

The detailed description of the appended drawings is intended as a description of preferred embodiments of the subject application and is not intended to represent the only form in which the subject application may be practiced. It should be understood that the same or equivalent functions may be accomplished by different embodiments that are intended to be encompassed within the spirit and scope of the subject application.

Reference will now be made in detail to some embodiments of the subject application, examples of which are illustrated in the accompanying drawings. To facilitate understanding, embodiments are provided under specific network architecture and new service scenarios, such as 3rd Generation Partnership Project (3GPP) LTE and LTE advanced, 3GPP 5G NR, 5G-Advanced, 6G, and so on. It is contemplated that along with developments of network architectures and new service scenarios, all embodiments in the subject application are also applicable to similar technical problems; and moreover, the terminologies recited in the subject application may change, which should not affect the principle of the subject application.

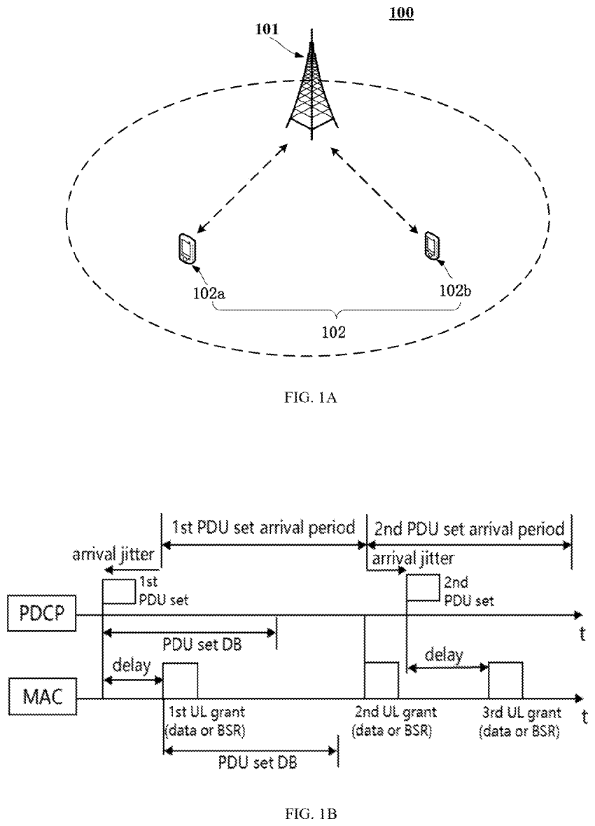

FIG. 1A illustrates a schematic diagram of a wireless communication system in accordance with some embodiments of the subject application. As shown in FIG. 1A, the wireless communication system 100 includes at least one base station (BS) 101 and at least one UE 102. In particular, the wireless communication system 100 includes one BS 101 and two UEs 102 (e.g., a UE 102a and a UE 102b) for illustrative purpose. Although a specific number of BS 101 and UEs 102 are depicted in FIG. 1A, it is contemplated that any number of BSs 101 and UEs 102 may be included in the wireless communication system 100.

The wireless communication system 100 is compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

BS 101 may also be referred to as a NG-RAN node, a RAN node, an access point, an access terminal, a base, a macro cell, a node-B, an enhanced node B (eNB), a gNB, a home node-B, a relay node, or a device, or described using other terminology used in the art. The BS 101 is generally part of a radio access network that may include a controller communicably coupled to BS 101.

According to some embodiments of the subject application, UE(s) 102 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some other embodiments of the subject application, UE(s) 102 may include a portable wireless communication device, a smart phone, a cellular telephone, a flip phone, a device having a subscriber identity module, a personal computer, a selective call receiver, or any other device that is capable of sending and receiving communication signals on a wireless network.

According to some other embodiments of the subject application, UE(s) 102 may include wearable devices, such as smart watches, fitness bands, optical head-mounted displays, or the like. Moreover, UE(s) 102 may be referred to as a subscriber unit, a mobile, a mobile station, a user, a terminal, a mobile terminal, a wireless terminal, a fixed terminal, a subscriber station, a user terminal, or a device, or described using other terminology used in the art.

Both UE 102a and UE 102b in the embodiments of FIG. 1A may transmit information to BS 101 and receive control information from BS 101, for example, via LTE or NR Uu interface.

As defined in 3GPP TR23.700-60, a new quality of service (QOS) parameter associated with PDU-Set is PDU-Set Delay Budget (PSDB), which defines an upper bound for the time that a PDU-Set may be delayed between a UE and the N6 termination point at the UPF. PSDB applies to the DL PDU-Set received by the UPF over the N6 interface, and to the UL PDU-Set sent by the UE. For a certain 5QI the value of the PSDB is the same in UL and DL. In the case of 3GPP access, the PSDB is used to support the configuration of scheduling and link layer functions (e.g., the setting of scheduling priority weights and HARQ target operating points).

According to 3GPP TR23.700-60, the 5G Access Network PDU-Set Delay Budget (5G-AN PSDB) is determined by subtracting a static value for the Core Network PDU-Set Delay Budget (CN PSDB), which represents the delay between any N6 termination point at the UPF (for any UPF that may possibly be selected for the PDU Session) and the 5G-AN from a given PSDB.

As defined in 3GPP TS38.323, regarding a service data unit (SDU) discard operation, when the discard timer expires for a PDCP SDU, or the successful delivery of a PDCP SDU is confirmed by a PDCP status report, the transmitting PDCP entity shall discard the PDCP SDU along with the corresponding PDCP Data PDU. If the corresponding PDCP Data PDU has already been submitted to lower layers, the discard is indicated to lower layers. For signaling radio bearers (SRBs), when upper layers request a PDCP SDU discard, the PDCP entity shall discard all stored PDCP SDUs and PDCP PDUs.

As defined in 3GPP TR23.501, the Packet Delay Budget (PDB) defines an upper bound for the time that a packet may be delayed between the UE and the N6 termination point at the UPF. The PDB applies to the DL packet received by the UPF over the N6 interface, and to the UL packet sent by the UE. For a certain 5QI the value of the PDB is the same in UL and DL. In the case of 3GPP access, the PDB is used to support the configuration of scheduling and link layer functions (e.g. the setting of scheduling priority weights and HARQ target operating points). The 5G Access Network Packet Delay Budget (5G-AN PDB) is determined by subtracting a static value for the Core Network Packet Delay Budget (CN PDB), which represents the delay between any N6 termination point at the UPF and the 5G-AN from a given PDB.

In general, XR, including AR and VR, as well as CG, presents a new promising category of connected devices, applications, and services. A UE with an XR service can be referred to as an XR device. XR-specific capacity improvements are key features. For example, there is a need to study mechanisms that provide more efficient resource allocation and scheduling for XR service characteristics (e.g., periodicity, multiple flows, jitter, latency, reliability, etc.). However, no such mechanism has been designed. Typically, an issue which may impact the system capacity is that a network is unaware of the accurate buffer delay for uplink (UL) PDU set schedule optimization due to the mismatched configured grant (CG) and a BSR transmission due to UL jitter of arrival time at the UE.

Currently, PDU set (e.g., a frame) level QOS parameters include a delay budget of a PDU set for XR traffic. The system capacity will be up to the PDU set based scheduled transmission within the PDU set delay budget. There is a case that if a fraction of resources are not aligned with traffic arrival due to UL jitter, the mismatch between CG and XR bursts may lead to delay. One possibility to avoid the transmission delay is to allocate multiple CG occasions to cover the UL PDU set arrival jitter range at a UE, but more resources are wasted. Therefore, it is valuable to assist a network to schedule UL transmission(s) within the PDU set delay budget in the case that the fraction of resources are allocated. Generally, the network determines the PDB duration from the expected PDU set periodic arrival time or BSR receiving timing. However, the network is not aware of the delay time of the data or BSR transmission(s) due to the mismatch between CG and early arrival XR burst. Thus, the network cannot determine the delayed time and perform the good scheduling policy to avoid exceeding the PDU set delay budget. A specific example is shown in embodiments of FIG. 1B. In this case, an issue for the capacity improvement needs to be addressed.

FIG. 1B illustrates an exemplary schematic diagram of a PDU set delay budget of XR traffic in accordance with some embodiments of the subject application. In the embodiments of FIG. 1B, PDU set(s) in PDU set arrival period(s) may arrive at a PDCP layer of a UE with arrival jitter. As shown in FIG. 1B, 1st PDU set in 1st PDU set arrival period arrives with negative arrival jitter, and 2nd PDU set in 2nd PDU set arrival period arrives with positive arrival jitter in time domain. Thus, there is delay between the arrival timing of the PDU set in 1st PDU set arrival period and the timing of a UL grant of a MAC layer of the UE, e.g., “1st UL grant (of data or BSR for transmission of the PDU set)”, in time domain. There is delay between the arrival timing of the PDU set in 2nd PDU set arrival period and the timing of a UL grant, e.g., “3rd UL grant (of data or BSR for transmission of the PDU set)”, in time domain.

Since 1st PDU set in 1st PDU set arrival period arrives earlier in time domain, “PDU set DB (delay budget)” of 1st PDU set in 1st PDU set arrival period is different from the original or initial “PDU set DB” of 1st PDU set transmitted on 1st UL grant (of data or BSR for transmission of the PDU set), as shown in FIG. 1B. Similarly, since 2nd PDU set in 2nd PDU set arrival period arrives later in time domain, “PDU set DB” (not shown in FIG. 1B) of 2nd PDU set in 2nd PDU set arrival period is also different from the original or initial “PDU set DB” (not shown in FIG. 1B) of 2nd PDU set transmitted on 3rd UL grant in time domain.

To resolve the abovementioned issues, embodiments of the subject application design a mechanism for a delay status report associated with a PDU set for a UL transmission of XR traffic.

More specifically, some embodiments of the subject application introduce a mechanism to enable the delay awareness scheduling for XR traffic for the capacity enhancement. In some embodiments of the subject application, a UE may receive a PDU set delay budget from a network and determine the remaining delay budget corresponding to a UL PDU set. In some embodiments of the subject application, a UE may transmit the remaining of delay budget report (DBR) of a PDU set to the network. The DBR may include information of a delay budget and information of an LCH, information of an LCG, and/or information of a PDU. In some embodiments of the subject application, a UE may determine delay information corresponding to a PDU set arriving at an access stratum (AS) layer of the UE from the upper layer at the UE. The delay information may be used to determine the remaining delay budget corresponding to the PDU set. Then, the UE may transmit a report including the delay information to the network. In embodiments of the subject application, a remaining delay budget may also be named as a left delay budget, an available delay budget, or the like.

More details will be illustrated in the following text in combination with the appended drawings. Persons skilled in the art should well know that the wording “a/the first,” “a/the second” and “a/the third” etc. are only used for clear description, and should not be deemed as any substantial limitation, e.g., sequence limitation.

FIG. 2 illustrates an exemplary flowchart regarding delay information associated with a PDU set in accordance with some embodiments of the subject application. The exemplary method 200 in FIG. 2 may be performed by a UE, e.g., UE 102 as shown in FIG. 1A. Although described with respect to a UE, it should be understood that other devices may be configured to perform a method similar to that of FIG. 2.

In the exemplary method 200 in FIG. 2, in operation 201, a UE determines delay information associated with one or more PDU sets received from an upper layer of the UE. The delay information may include at least one of:
(1) A remaining PDU set delay budget. In some embodiments, the remaining PDU set delay budget corresponds to one PDU set with a minimum delay budget within the one or more PDU sets in an LCH or in an LCG or in a MAC entity of the UE or in the UE.
(2) A PDU set buffer delay. In some embodiments, the PDU set buffer delay corresponds to one PDU set with a maximum buffer delay within the one or more PDU sets in an LCH or in an LCG or in a MAC entity of the UE or in the UE.
(3) A PDU set delay budget offset.
(4) Timing when receiving a PDU within the one or more PDU sets from the upper layer. The timing is denoted as “the first timing” for simplicity in following text. In some embodiments, the first timing corresponds to one PDU set with earliest arriving timing within the one or more PDU sets in an LCH or in an LCG or in a MAC entity of the UE or in the UE.

In operation 202, the UE transmits a report including the delay information. The report may be at least one of:
(1) a delay budget report (DBR);
(2) a delay report (DR);
(3) an arriving timing report (ATR); or
(4) an enhanced buffer status report (EBSR).

In some embodiments, the delay information includes delay information associated with a first arrival PDU or a last arrival PDU of one PDU set within the one or more PDU sets in an LCH or in an LCG or in a MAC entity of the UE or in the UE. The first arrival PDU set is the PDU within the one PDU firstly arrived in time domain. The last arrival PDU is the PDU within the one PDU set lastly arrived in time domain.

In some embodiments, the delay information includes delay information corresponding to one PDU set within the one or more PDU sets with a highest priority logical channel allowed to report the delay information in an LCG or in a MAC entity of the UE or in the UE.

In some embodiments, the delay information includes at least one of:
(1) delay information corresponding to one PDU set within the one or more PDU sets with a logical channel with or without data available for transmission; or
(2) delay information corresponding to one PDU set within the one or more PDU sets in an LCG with or without data available for transmission.

In some embodiments, the delay information is determined according to at least one of:
(1) A packet delay budget.
(2) A SDU discard timer.
   (3) A packet delay budget offset.
(4) A PDU set delay budget.
(5) A PDU set delay budget timer.
(6) A PDU set discard timer.
(7) A PDU set delay budget offset. In some embodiments, the PDU set delay budget offset may be received from the upper layer of the UE.
(8) Reference time related to the PDU set. In an embodiment, the reference time is: timing of assembling a MAC PDU including the delay information into a medium access control (MAC) PDU; or timing of transmitting the report.
(9) The first timing as mentioned above.

In some embodiments, the one or more PDU sets are received by an AS layer of the UE. The first timing may include at least one of:
(1) arriving timing at the AS layer of a first arrival PDU within the one or more PDU sets from the upper layer; or
(2) arriving timing at the AS layer of a certain PDU (e.g., with important indication or I-slice type indication) within the one or more PDU sets from the upper layer; or
(3) arriving timing at the AS layer of a last arrival PDU within the one or more PDU sets from the upper layer.

In some embodiments, to determine the remaining PDU set delay budget, the UE may start the PDU set delay budget timer upon receiving a PDU within the PDU set from the upper layer, stop the PDU set delay budget timer at the reference time, and determine a remaining length value of the PDU set delay budget timer.

In some embodiments, the remaining PDU set delay budget is determined based on:
(1) a sum of the PDU set delay budget and the PDU set delay budget offset; or
(2) a sum of a remaining length value of the PDU set delay budget timer and the PDU set delay budget offset.

In some embodiments, the remaining PDU set delay budget is determined based on the PDU set delay budget, the first timing, and the reference time; the remaining PDU set delay budget is determined based on the PDU set delay budget offset, the PDU set delay budget, the first timing, and the reference time; or the PDU set buffer delay is determined based on the first timing and the reference time.

In some embodiments, the UE may transmit an indication for indicating a capability of the UE for supporting a transmission of the report to the network.

In some embodiments, the UE may receive a configuration related to the delay information from the network. In an embodiment, the configuration related to the delay information includes at least one of:
(1) information for enabling a transmission of the report;
(2) a trigger threshold associated with the trigger condition;
(3) a cancel threshold associated with a cancel condition;
(4) a packet delay budget;
(5) a length of a SDU discard timer;
(6) the PDU set delay budget;
(7) a length of the PDU set delay budget timer;
(8) a length of a PDU set discard timer;
(9) a length of a SDU discard timer;
(10) a length of a periodic timer associated with the report; or
(11) a length of a retransmission timer associated with the report.

In some embodiments, the configuration related to the delay information is associated with:
(1) an LCH allowed to report the delay information;
(2) an LCG allowed to report the delay information;
(3) a DRB allowed to report the delay information; or
(4) a MAC entity of the UE allowed to report the delay information.

In some embodiments, the report transmitted in operation 202 includes at least one of: information of an LCH corresponding to the delay information (e.g., an LCH ID); information of an LCG corresponding to the delay information (e.g., an LCG ID); information of a DRB corresponding to the delay information (e.g., a DRB ID); or information associated with the one or more PDU sets.

In some embodiments, the UE may trigger the report based on a trigger condition. In an embodiment, the trigger condition includes at least one of:
(1) upon receiving a first arrival PDU within the one or more PDU sets from the upper layer;
(2) upon receiving a PDU with an important indication (e.g., key frame indicator or I-frame type indicator) within the one or more PDU sets from the upper layer;
(3) upon receiving a last arrival PDU within the one or more PDU sets from the upper layer;
(4) upon an expiry of a periodic timer associated with the report; The UE may start the periodic timer after transmission of the report.
(5) upon an expiry of a retransmission timer associated with the report; The UE may start the periodic timer after transmission of the report.
(6) upon the PDU set delay budget being less than or equal to a trigger threshold associated with the trigger condition;
(7) upon the PDU set delay being greater than or equal to a trigger threshold associated with the trigger condition;
(8) upon a total number of padding bits of allocated UL resources being greater than or equal to a bit size of a MAC sub-PDU including the report;
(9) upon a request from the upper layer; or
(10) upon receiving a dynamic report request (e.g., DL MAC CE or DL DCI or DL PDCP control PDU) from a network.

In some embodiments, the report is transmitted in response to unfulfillment of a cancel condition. In some embodiments, the UE may cancel the report based on a cancel condition. The cancel condition may include at least one of:
(1) in case that the remaining PDU set delay budget is less than or equal to a cancel threshold;
(2) in case that the PDU set delay is greater than or equal to a cancel threshold;
(3) upon an expiry of a PDU set delay budget timer;
(4) upon an expiry of a SDU discard timer;
(5) upon an expiry of a PDU set discard timer;
(6) upon transmitting a MAC PDU including the report, wherein the report is triggered prior to assembling the MAC PDU or at timing of assembling the MAC PDU;
(7) in case that padding bits of allocated UL resources are sufficient to accommodate a MAC PDU without the report but not sufficient to accommodate a MAC PDU with the report; or
(8) in case that the padding bits of the allocated UL resources are sufficient to accommodate a MAC PDU without the report but not sufficient to accommodate a MAC PDU with the report, and that the report is triggered with a highest logical channel priority being less than or equal to a logical channel priority of all pending data available.

In some embodiments, a MAC sub-PDU including the report carries at least one of:
(1) one remaining PDU set delay budget related to a PDU set within the one or more PDU sets for one LCH;
(2) two or more remaining PDU set delay budgets related to two or more PDU sets within the one or more PDU sets for the one LCH;
(3) multiple remaining PDU set delay budgets related to multiple PDU sets within the one or more PDU sets for two or more LCHs;
(4) one remaining PDU set delay budget related to the one or more PDU sets for one LCG;
(5) two or more remaining PDU set delay budgets related to two or more PDU sets within the one or more PDU sets for the one LCG;
(6) multiple remaining PDU set delay budgets related to multiple PDU sets within the one or more PDU sets for two or more LCGs;
(7) a PDU set delay budget offset related to a PDU set within the one or more PDU sets for the one LCH or for the one LCG; or
(8) multiple remaining PDU set delay budget offsets related to multiple PDU sets within the one or more PDU sets for the two or more LCHs or for the two or more LCGs.

In some embodiments, in response to determining that the delay information includes piece(s) of delay information for LCH(s) or LCG(s), the UE may prioritize the piece(s) of delay information. The report may include all or a part of the prioritized piece(s) of delay information.

In some embodiments, in response to padding bits of allocated UL resources being not sufficient to accommodate piece(s) of delay information included in the report for LCH(s) or LCG(s), the UE may:
(1) prioritize the piece(s) of delay information in a decreasing order of priorities of the LCH(s); or
(2) in case that the piece(s) of delay information have an equal logical channel priority, prioritize the piece(s) of delay information in an increasing order or a decreasing order of the value of the delay information. The report may include a part of the prioritized piece(s) of delay information; or
(3) prioritize the piece(s) of delay information in a decreasing order of the highest priority logical channel in each of the LCG(s); or
(4) in case that the piece(s) of delay information have an equal highest logical channel priority in each of the LCG(s), prioritize the piece(s) of delay information in an increasing order or a decreasing order of the value of the delay information. The report may include a part of the prioritized piece(s) of delay information.

In some embodiments, there may be any of following cases:
(1) a priority of a MAC CE of one type of the report (e.g., a regular report or a periodic report) is greater than or equal to a priority of a MAC CE for one type of a BSR (e.g., a regular BSR or a periodic BSR);
(2) the priority of the MAC CE of the one type of the report is less than or equal to the priority of the MAC CE for the one type of the BSR;
(3) a relation between the priority of the MAC CE of the one type of the report and the priority of the MAC CE for the one type of the BSR is depends upon the UE's implementation; for example, the same priority may be considered.
(4) a priority of a MAC CE of a further type of the report (e.g., a padding report) is greater than or equal to a priority of a MAC CE for a further type of the BSR (e.g., a padding BSR);
(5) the priority of the MAC CE of the further type of the report is less than or equal to the priority of the MAC CE for the further type of the BSR; or
(6) relation between the priority of the MAC CE of the further type of the report and the priority of the MAC CE for the further type of the BSR is depends upon the UE's implementation.

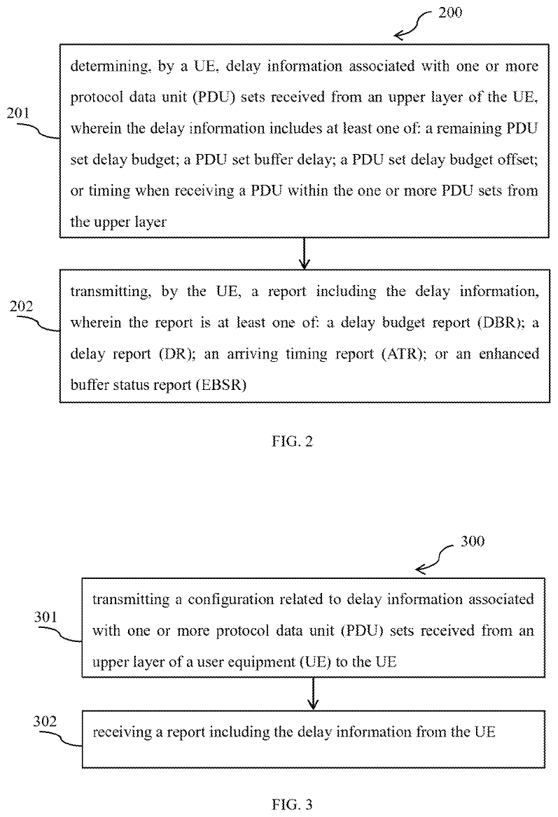

FIG. 3 illustrates a further exemplary flowchart regarding delay information associated with a PDU set in accordance with some embodiments of the subject application. The exemplary method 300 in FIG. 3 may be performed by a network node, for example, a BS (e.g., BS 101 as shown in FIG. 1A). Although described with respect to a network node, it should be understood that other devices may be configured to perform a method similar to that of FIG. 3.

In the exemplary method 300 in FIG. 3, in operation 301, a network node transmits a configuration related to delay information associated with one or more PDU sets received from an upper layer of a UE to the UE. In operation 302, the network node receives a report including the delay information from the UE.

In some embodiments, the delay information includes at least one of:
(1) A remaining PDU set delay budget. For instance, the remaining PDU set delay budget may correspond to one PDU set with a minimum delay budget within the one or more PDU sets in an LCH or in an LCG or in a MAC entity of the UE or in the UE.
(2) A PDU set buffer delay. For instance, the PDU set buffer delay may correspond to one PDU set with a maximum buffer delay within the one or more PDU sets in an LCH or in an LCG or in a MAC entity of the UE or in the UE.
(3) A PDU set delay budget offset.
(4) Timing when receiving a PDU within the one or more PDU sets from the upper layer. The timing may be denoted as “the first timing” for simplicity. For instance, the first timing may correspond to one PDU set with earliest arriving timing within the one or more PDU sets in an LCH or in an LCG or in a MAC entity of the UE or in the UE.

In some embodiments, the delay information includes delay information associated with a first arrival PDU or a last arrival PDU of one PDU set within the one or more PDU sets.

In some embodiments, the delay information includes delay information corresponding to one PDU set within the one or more PDU sets in an LCH or in an LCG or in a MAC entity of the UE or in the UE with a highest priority logical channel allowed to report the delay information in an LCG or in a MAC entity of the UE or in the UE.

In some embodiments, the first timing includes at least one of:
(1) arriving timing at a AS layer of the UE of a first arrival PDU within the one or more PDU sets from the upper layer; or
(2) arriving timing at the AS layer of a certain PDU within the one or more PDU sets from the upper layer; or
(3) arriving timing at the AS layer of a last arrival PDU within the one or more PDU sets from the upper layer.

In some embodiments, the delay information includes at least one of:
(1) delay information corresponding to one PDU set within the one or more PDU sets with a logical channel with or without data available for transmission; or
(2) delay information corresponding to one PDU set within the one or more PDU sets in an LCG with or without data available for transmission.

In some embodiments, the configuration related to delay information transmitted in operation 301 includes at least one of:
(1) information for enabling a transmission of the report;
(2) a trigger threshold associated with a trigger condition of the report;
(3) a cancel threshold associated with a cancel condition of the report;
(4) a packet delay budget;
(5) a length of a SDU discard timer;
(6) a PDU set delay budget;
(7) a length of a PDU set delay budget timer;
(8) a length of a PDU set discard timer;
(9) a length of a SDU discard timer;
(10) a length of a periodic timer associated with the report; or
(11) a length of a retransmission timer associated with the report.

In some embodiments, the configuration related to delay information is associated with:
(1) an LCH allowed to report the delay information;
(2) an LCG allowed to report the delay information;
(3) a DRB allowed to report the delay information; or
(4) a MAC entity of the UE allowed to report the delay information.

In some embodiments, the report received in operation 302 is at least one of:
(1) a delay budget report (DBR);
(2) a delay report (DR);
(3) an arriving timing report (ATR); or
(4) an enhanced buffer status report (EBSR).

In some embodiments, the report includes at least one of:
(1) information of a logical channel (LCH) corresponding to the delay information;
(2) information of a logical channel group (LCG) corresponding to the delay information;
(3) information of a data radio bearer (DRB) corresponding to the delay information; or
(4) information associated with the one or more PDU sets.

In some embodiments, the report is included in a MAC sub-PDU, and the MAC sub-PDU includes at least one of:
(1) one remaining PDU set delay budget related to a PDU set within the one or more PDU sets for one LCH;
(2) two or more remaining PDU set delay budgets related to two or more PDU sets within the one or more PDU sets for the one LCH;
(3) multiple remaining PDU set delay budgets related to multiple PDU sets within the one or more PDU sets for two or more LCHs;
(4) one remaining PDU set delay budget related to the one or more PDU sets for one LCG;
(5) two or more remaining PDU set delay budgets related to two or more PDU sets within the one or more PDU sets for the one LCG; or
(6) multiple remaining PDU set delay budgets related to multiple PDU sets within the one or more PDU sets for two or more LCGs.

In some embodiments, the network node may receive an indication for indicating a capability of the UE for supporting a transmission of the report from the UE.

It should be appreciated by persons skilled in the art that the sequence of the operations in the exemplary flowcharts 200 and 300 may be changed, and some of the operations in the exemplary flowcharts 200 and 300 may be eliminated or modified, without departing from the spirit and scope of the disclosure. Details described in all other embodiments of the subject application, e.g., in the embodiments of FIGS. 2 and 3 are applicable for this exemplary flowchart. Moreover, details described in this exemplary flowchart are applicable for all the embodiments of FIGS. 1A, 1B, and 4-9.

In some embodiments of the subject application, a UE reports a left or remaining or available PDU set delay budget according to a PDU set delay budget to a network. For instance, a UE may determine the left delay budget corresponding to a PDU set according to at least the delay budget, and may report the delay budget report (DBR) corresponding to the PDU set to the network, in order to assist the network to determine the left or remaining or available delay budget corresponding to a PDU set when the network receives the report from the UE. The DBR may be included in a MAC CE, a PDCP control PDU, an RLC status report, or uplink physical control information, or may be included in Layer 2 header (e.g., the L2 header of the first arrival PDU of the PDU set or the L2 header of an enhanced BSR (EBSR) for transmission (the first arrival PDU of) of the PDU set).

In some embodiments, a PDU set can be replaced by a frame or data burst. In some embodiments, the 5G-AN PDU set delay budget may be configured by the network or configured as a default value. In some embodiments, the delay budget can be replaced by the 5G-AN PDU set discard timer which is configured by the network. In some embodiments, the delay budget can be replaced by the 5G-AN SDU discard timer which is configured by the network. In some embodiments, the delay budget can be replaced by the packet delay budget which is configured by the network.

In some embodiments, the MAC entity at a UE determines the left delay budget corresponding to a PDU set according to the delay budget configured by the network, and reports the DBR corresponding to a PDU set to the network. In some embodiments, the network may configure the DBR, e.g., as shown in FIG. 4.

FIG. 4 illustrates an exemplary flowchart of a configuration procedure for a delay status (or information) report in accordance with some embodiments of the subject application.

In operation 411, UE 401 may report DBR capability to network 402 (e.g., gNB).

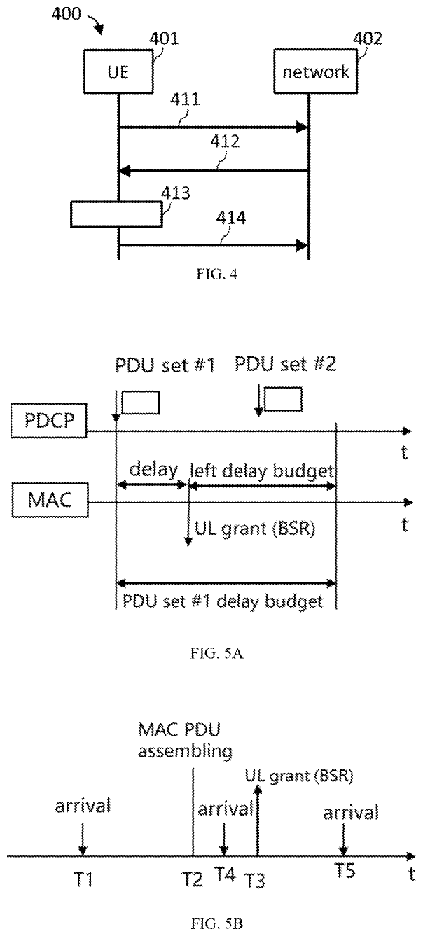

In operation 412, network 402 transmits DBR configuration(s) to UE 401 in an RRC message (e.g., RRCReconfiguration message), which is used to enable the report about the available delay budget, the remaining delay budget, time instance T1 (e.g., as shown in FIG. 5B), or a delay budget offset corresponding to a PDU set.

For example, DBR configuration(s) may include at least one of following information elements (IEs):
(1) Delay Budget (DB). This IE indicates the available access network delay budget value corresponding to a PDU set of an LCH or DRB upon the first or last reception of a PDU corresponding to the PDU set from the upper layer. The Access Network Delay Budget (5G-AN PDB) represents the delay budget for transmission a PDU set between access stratum (e.g., PDCP layer or MAC layer) at UE 401 and the AS (e.g., PDCP layer or MAC layer) at network 402 from a given PDB.
(2) periodicDBR-Timer. This IE indicates the value of the periodical DBR timer of an LCH or an LCG or a MAC entity in the UE.
(3) retxDBR-Timer. This IE indicates the value of the retransmission DBR timer of an LCH or an LCG or a MAC entity in the UE.
(4) DBR Trigger threshold. This IE indicates a trigger threshold of an LCH or an LCG or a MAC entity in the UE for the DBR.
(5) DBR Cancel threshold. This IE indicates a cancel threshold of an LCH or an LCG or a MAC entity in the UE for the DBR.
(6) DBR Allowed report logical channel or logical channel group or a MAC entity of UE. This IE indicates that the delay budget report to network 402 is allowed for the LCH or the LCG or the MAC entity in the UE or the UE.
(7) DBR Allowed report data radio bearer. This IE indicates that the delay budget report to network 402 is allowed for the DRB.

In operation 413, after UE 401 receives the DBR configuration(s) from network 402, UE 401 indicates the DBR configuration(s) for the LCH or the LCG or the MAC entity to the MAC entity, and indicates the DBR configuration(s) for the DRB to the PDCP entity.

In operation 414, UE 401 transmits an RRCReconfigurationComplete message to network 402 for the DBR configuration(s).

FIGS. 5A and 5B illustrate exemplary schematic diagrams of a PDU set delay budget of XR traffic in accordance with some embodiments of the subject application.

As shown in FIG. 5A, for XR traffic including PDU set #1 and PDU set #2, since PDU set #1 arrives earlier at a PDCP layer of a UE with arrival jitter in time domain, there is a buffer delay between the arrival timing of PDU set #1 and UL grant (for transmission of DBR or EBSR or BSR (for transmion of the first arrival PDU) of the PDU set #1) of a MAC layer of the UE. Thus, “PDU set #1 delay budget” includes “delay” and “left delay budget” as shown in FIG. 5A.

In some embodiments, the UE may determine a left delay budget corresponding to a PDU set of an LCH or an LCG. A specific example is described in the embodiments of FIG. 5B as below.

Timing values in FIG. 5B correspond to the embodiments of FIG. 5A. As shown in FIG. 5B, T1, T4, and T5 are three arrival timing values of PDU sets. T2 is MAC PDU assembling timing. T3 is timing of UL grant (for transmission of DRB or EBSR or BSR for transmission of (the first arrival PDU of) the PDU set). For example:
T1=Timing of first or last reception of a PDU belonging to the PDU set from an upper layer of the UE. The PDU may be an important PDU belonging to the PDU set.
T2=MAC PDU assembling timing of the DBR related to the PDU set (e.g., the first arrival PDU or last arrival PDU of the PDU set). In some embodiments, “MAC PDU assembling” may also be named as “MAC PDU multiplexing” or the like.
T3=Timing of the beginning or ending of the UL grant for transmitting the MAC PDU including DBR related to the PDU set or for transmitting the first arrival PDU of the PDU set or for transmitting the EBSR or BSR for transmission of (the first arrival PDU of) the PDU set.

In some embodiments of FIGS. 5A and 5B, a MAC entity of a UE may acquire T1 value from a PDCP layer of a DRB of an LCH. The PDCP entity of the UE may notify the MAC entity that a PDU set arrives at the AS layer of the UE. The PDCP entity of the UE may notify the corresponding information (e.g., identification (ID)) of the PDU set. The MAC entity may acquire T2 or T3 at the MAC layer.

The left delay budget in FIG. 5A may be calculated based on timing values in FIG. 5B. In an embodiment, the left delay budget=“PDU set #1 delay budget”−(T2−T1). In a further embodiment, the left delay budget=“PDU set #1 delay budget”−(T3-T1).

In some embodiments, PDU set #1 delay budget can be replaced by the packet delay budget or the length of the SDU discard timer or the length of the PDU Set discard timer. For example, the left delay budget=“packet delay budget”−(T2−T1), or the left delay budget=“packet delay budget”−(T3−T1). For example, the left delay budget=“the length of SDU discard timer”−(T2−T1), or the left delay budget=“the length of SDU discard timer”−(T3−T1). For example, the left delay budget=“the length of PDU set discard timer”−(T2−T1), or the left delay budget=“the length of PDU set discard timer”−(T3−T1).

In some other embodiments of FIGS. 5A and 5B, upon first or last reception of a PDU belonging to a PDU set from an upper layer of a UE, a PDCP entity of the UE may notify the MAC entity of the UE that the PDU set arrives at the AS of the UE. The PDCP entity may also notify the corresponding PDU set information, e.g., an ID of the PDU set. The MAC entity may set a delay budget timer corresponding to the PDU set to the delay budget configured by an RRC message, and start the delay budget timer upon reception the notification from the PDCP entity. The delay budget timer counts down. Then, the MAC entity may determine the remaining length value of the delay budget timer as the available delay budget till reference time. The reference time can be the timing when multiplexing or assembling the DBR related to the PDU set in a MAC PDU or the transmission timing of the DBR related to the PDU set. In some other embodiments, the MAC entity may set a delay budget timer corresponding to the PDU set to the packet delay budget or SDU discard timer or PDU set discard timer configured by an RRC message.

In some further embodiments of FIGS. 5A and 5B, a PDCP entity of a UE may set a delay budget timer corresponding to a PDU set to the delay budget configured by an RRC message and start the delay budget timer upon first or last reception of a PDU belonging to the PDU set from an upper layer of the UE. The delay budget timer counts down. The MAC entity may acquire the remaining value of the delay budget timer from the PDCP layer of a DRB as the available delay budget when multiplexing the DBR in a MAC PDU. The gap between the timing multiplexing the DBR in the MAC PDU and beginning of the UL grant for the MAC PDU transmission may be ignored. The delay budget configured by an RRC message can be replaced by the packet delay budget or SDU discard timer or PDU set discard timer by an RRC message.

In some embodiments of the subject application, a UE may trigger a delay budget report (DBR) with an LCH (with or without data available for transmission) configured for a DBR, if at least one of following trigger conditions is met:
(1) When the first or last PDU belonging to a PDU set arrives at the AS layer, e.g., the PDCP layer of the UE. In this case, the DBR may be referred below to as “Regular DBR”.
(2) When a PDU belonging to a PDU set with an important indication (e.g., a key frame indicator or an I-frame type indicator) from an upper layer arrives at the AS layer, e.g., a PDCP layer. In this case, the DBR may be referred below to as “Regular DBR”.
(3) Upon an expiry of retxDBR-Timer. For example, the UE starts the retxDBR-Timer after the DBR transmission. For a DBR triggered by an expiry of the retxDBR-Timer, at least one of LCHs (allowed to report the delay budget) which belong to an LCG contains UL data. In this case, the DBR may be referred below to as “Regular DBR”. The UE may consider that the LCH that triggered the DBR is the LCH with the highest priority (with or without data available for transmission) at the time when the DBR is triggered.
(4) Upon an expiry of periodicDBR-Timer. For example, the UE starts the periodicDBR-Timer after the DBR transmission. In this case, the DBR may be referred below to as “Periodic DBR”.
(5) When the delay budget corresponding to a PDU set is less than or equal to a trigger threshold configured by an RRC message. In this case, the DBR may be referred below to as “Regular DBR”.
(6) UL resources are allocated, and a total number of padding bits of the UL resources is greater than or equal to a size of a MAC CE of the DBR plus its subheader. In this case, the DBR may be referred below to as “Padding DBR”.
(7) Requested by upper layers of the UE to report the DBR for an LCH and for a direction (e.g., UL);
(8) UL data for an LCH (allowed to report the delay budget) becomes available to the MAC entity of the UE. In this case, the DBR may be referred below to as “Regular DBR”. For example:
   the UL data belongs to an LCH (allowed to report the delay budget) with a priority higher than the priority of any LCH (allowed to report the delay budget) containing available UL data; or
   none of the LCHs (allowed to report the delay budget) contains any available UL data.

In some embodiments of the subject application, a UE may cancel a DBR if at least one of following cancel conditions is met:
(1) The remaining delay budget of a PDU set is less than or equal to a cancel threshold.
(2) The delay budget timer corresponding to a PDU set or a PDU within a PDU set expiries, i.e., remaining delay budget=0.
(3) The discard timer corresponding to a PDU set expiries.
(4) The discard timer corresponding to a SDU of a PDU within a PDU set expiries.
(5) All DBRs triggered prior to the MAC PDU assembling timing shall be cancelled when the MAC PDU is transmitted and this MAC PDU includes the DBR which contains PDU set delay budget status up to (and including) the last event that triggers the DBR prior to the MAC PDU assembling timing.
(6) When UL grant(s) can accommodate all pending data available corresponding to PDU set(s) for transmission, but the UL grant(s) is not sufficient to additionally accommodate the MAC CE of (padding) DBR plus its MAC subheader.
(7) When the UL grant(s) can accommodate all pending data available corresponding to PDU set(s) for transmission, but the UL grant(s) is not sufficient to additionally accommodate the MAC CE of (padding) DBR plus its MAC subheader, and if the DBR triggered with the highest logical channel priority is less than or equal to a logical channel priority corresponding to all the pending data available for transmission.

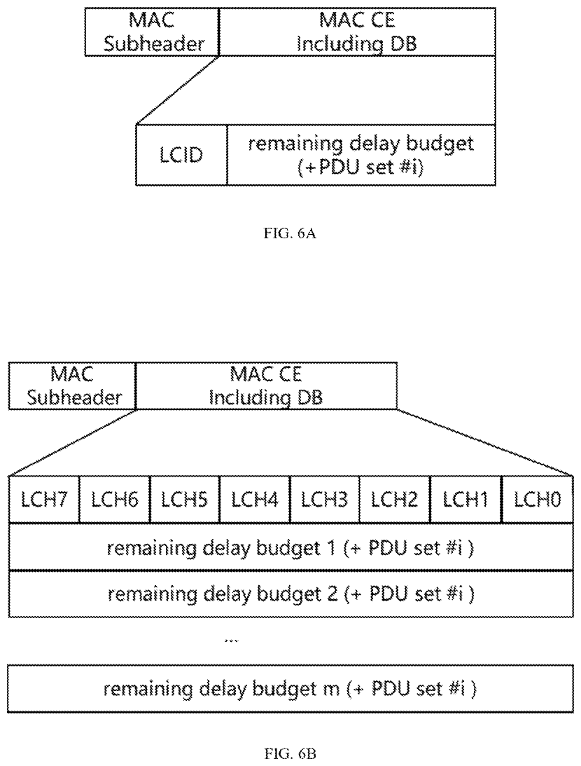

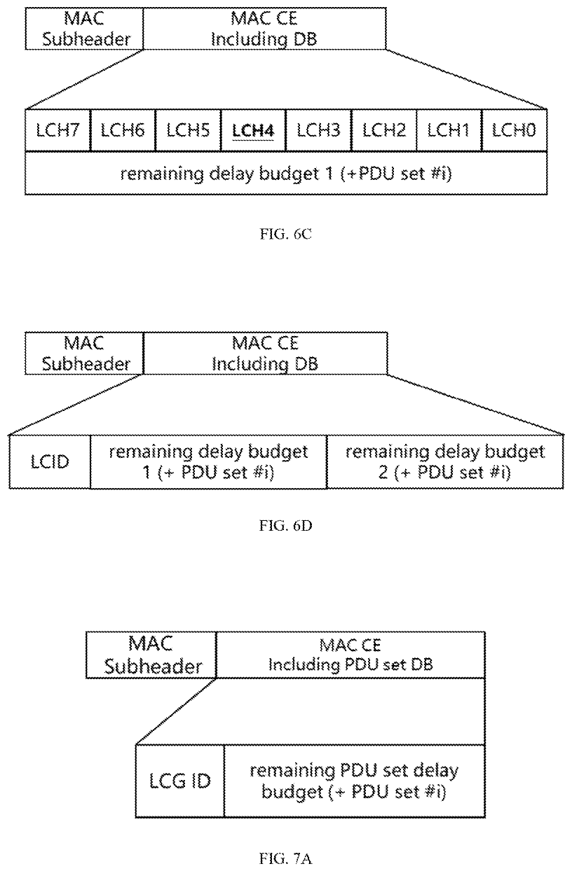

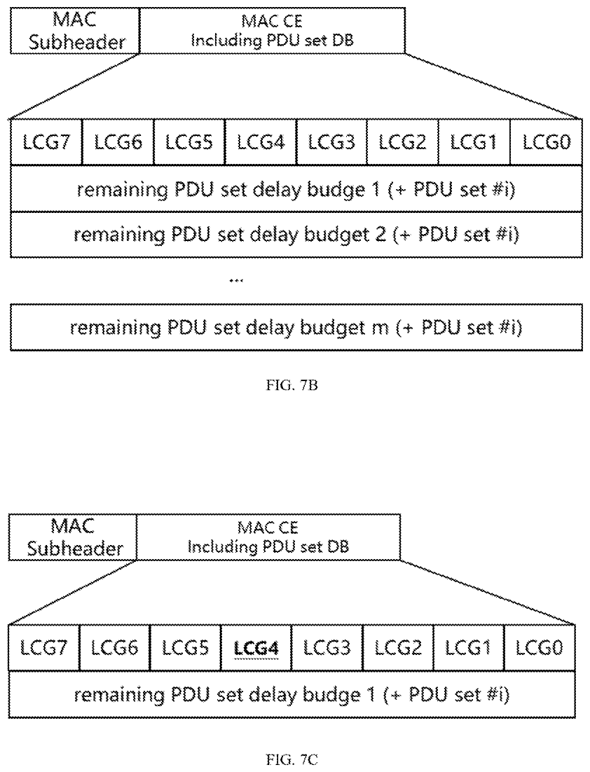

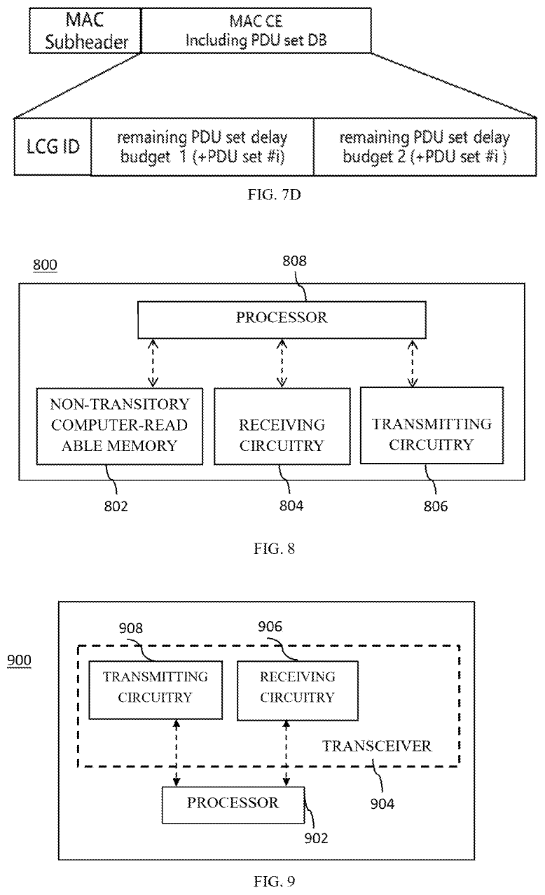

Some embodiments of the subject application refer to a DBR format design, e.g., FIGS. 6A-6D and 7A-7D. A MAC PDU may contain at most one DBR, even when multiple events have triggered a DBR. In some embodiments, a DBR may be per an LCH, e.g., the embodiments of FIGS. 6A-6D. In some other embodiments, a DBR may be per an LCG, e.g., the embodiments of FIGS. 7A-7D.

FIGS. 6A-6D illustrate exemplary MAC PDUs including a remaining delay budget in accordance with some embodiments of the subject application.

The embodiments of FIG. 6A refer to one delay budget for one LCH in short DBR format or short truncated DBR format. FIG. 6A shows a MAC sub-PDU of the DBR format, which includes one DBR for one LCH. In particular, the MAC sub-PDU includes a MAC subheader and a MAC CE including following fields:
(1) DB (delay budget): this field indicates the remaining delay budget corresponding to a PDU set (with the lowest delay budget) for an LCH (with or without data available for transmission) after the MAC PDU has been built. The LCH may be with the highest logical channel priority in a MAC entity of the UE or in the UE. The PDU set may be with the lowest delay budget in a MAC entity of the UE or in the UE. The LCH may be with or without data available for transmission after the MAC PDU has been built. The data available for transmission definition can be referenced in 3GPP TS38322 and TS38.323. For example, the DB may be:
   a) Code index, e.g., 1 represents 2 ms, 2 represents 2.5 ms, 3 represents 3 ms; or b) Absolute value, e.g., 1 ms, 1.5 ms, 2 ms, 2.5 ms, or 3 ms. A ms is a millisecond.
(2) LCID (LCH identification): this field identifies the logical channel whose delay budget is reported.

Optionally, the MAC sub-PDU in FIG. 6A may further include a PDU set information (e.g., a PDU set ID). The PDU set ID field indicates the PDU set corresponding to the DB field, e.g., the MAC CE includes “remaining delay budget+PDU set #i” as shown in FIG. 6A. For instance, the PDU set ID may be:
(1) PDU set Sequence Number (SN); or
(2) Code index, e.g., 0 represents current PDU set being transmitted, or 1 represents next PDU set to be transmitted.

The embodiments of FIG. 6B refer to one delay budget for each LCH within all LCHs having data available for transmission and/or having DBR for transmission in long DBR format. The embodiments of FIG. 6C refer to one delay budget for each LCH within parts of all LCHs having data available for transmission and/or having DBR for transmission in long truncated DBR format in case that the UL grant is not enough to accommodate the DBR for all LCHs. FIGS. 6B and 6C show MAC sub-PDUs of the DBR format, which is DBR for one or more LCHs. In particular, the MAC sub-PDU includes a MAC subheader and a MAC CE including following fields.
(1) DB: this field indicates the remaining delay budget corresponding to a PDU set (with the lowest delay budget) for the LCH (with or without data available for transmission) after the MAC PDU has been built. The PDU set may be with the lowest delay budget in a MAC entity of the UE or in the UE. The LCH may be with or without data available for transmission after the MAC PDU has been built. For the long DBR format and the long truncated DBR format, the DB fields are included in ascending order based on the LCHi.
(2) LCHi: e.g., LCH0 to LCH7 as shown in FIGS. 6B and 6C.
   a) For the long DBR format as shown in FIG. 6B, the LCHi field indicates the presence of the remaining delay budget field for the logical channel i. The LCHi field set to 1 indicates that the remaining delay budget field for the logical channel i is reported. The LCHi field set to 0 indicates that the Delay Budget field for the logical channel i is not reported. For example, as shown in FIG. 6B, m LCHs may be set to 1 to indicates that m logical channels have the remaining delay budget, i.e., remaining delay budget 1, remaining delay budget 2, and remaining delay budget m. In an embodiment, if m=4, there may be 4 remaining delay budgets corresponding to 4 LCHs, respectively.
   b) For the long truncated DBR format as shown in FIG. 6C, the LCHi field indicates whether logical channel i has the remaining delay budget. The LCHi field set to 1 indicates that logical channel i has the remaining delay budget for transmission. The LCHi field set to 0 indicates that logical channel i does not have a delay budget for transmission. For example, as shown in FIG. 6C, LCH4 is set to 1 to indicates that logical channel 4 has the remaining delay budget, i.e., remaining delay budget 1.

Optionally, the MAC sub-PDU in FIGS. 6B and 6C may further include a PDU set information (e.g., a PDU set ID), which indicates the PDU set corresponding to the DB, e.g., “remaining delay budget 1+PDU set #i”, “remaining delay budget 2+PDU set #i”, or “remaining delay budget m+PDU set #i” as shown in FIG. 6B or FIG. 6C. For instance, the PDU set ID may be a PDU set SN or a code index.

The embodiments of FIG. 6D refer to more than one DB for each LCH. FIG. 6D shows a MAC sub-PDU of the DBR format, which includes two delay budgets for one LCH in long DBR format. The two delay budgets may be placed in an increasing order or in a decreasing order of the delay budget of each PDU set. Similar to FIG. 6A, the MAC sub-PDU in FIG. 6D includes a MAC subheader and a MAC CE including LCID and two DBs, e.g., remaining delay budget 1 and remaining delay budget 2. Optionally, the MAC sub-PDU in FIG. 6D may further include a PDU set information corresponding to the DB, e.g., “remaining delay budget 1+PDU set #i” or “remaining delay budget 2+PDU set #i” as shown in FIG. 6D. Optionally, the number of the DB filed for the LCH is indicated in the MAC subheader or in another field in the MAC CE payload.

FIGS. 7A-7D illustrate exemplary MAC PDUs including a remaining PDU set delay budget in accordance with some embodiments of the subject application.

The embodiments of FIG. 7A refer to one delay budget for one LCG in short DBR format or short truncated DBR format. FIG. 7A shows a MAC sub-PDU of the DBR format, which includes one DBR for one LCG. In particular, the MAC sub-PDU includes a MAC subheader and a MAC CE including LCG ID and PDU set DB (delay budget).
(1) DB: this field indicates the remaining delay budget corresponding to a PDU set (with the lowest delay budget) with an LCH (with the highest priority logical channel) (with or without data available for transmission) in an LCG. The LCG may be with the highest logical channel priority in a MAC entity of the UE or in the UE. The LCH may be with the highest logical channel priority in an LCG. The PDU set may be with the lowest delay budget in a MAC entity of the UE or in the UE. The LCG may be with or without data available for transmission after the MAC PDU has been built. The data available for transmission definition can be referenced in 3GPP TS38322 and TS38.323. For example, the DB in FIG. 7A is remaining PDU set delay budget.
(2) LCG ID: this field identifies the group of LCH(s) whose delay budget is being reported.

Optionally, the MAC sub-PDU in FIG. 7A may further include a PDU set identification: indicate the PDU set corresponding to the DB. For example, the DB in FIG. 7A is remaining PDU set delay budget+PDU set #i.

The embodiments of FIG. 7B refer to one delay budget for each LCG within all LCGs having data available for transmission and/or having DBR for transmission in long DBR format. The embodiments of FIG. 7C refer to one delay budget for each LCG within parts of all LCGs having data available for transmission and/or having DBR for transmission in long truncated DBR format in case that the UL grant is not enough to accommodate the DBR for all LCGs. FIGS. 7B and 7C show MAC sub-PDUs of the DBR format, which is DBR for one or more LCGs.
(1) DB: this field indicates the remaining delay budget corresponding to a PDU set (with the lowest delay budget) for an LCH (with the highest priority logical channel) (with or without data available for transmission) in an LCG after the MAC PDU has been built. The LCH may be with the highest logical channel priority in an LCG. The PDU set may be with the lowest delay budget in a MAC entity of the UE or in the UE. The LCG may be with or without data available for transmission after the MAC PDU has been built. For the long DBR format and the long truncated DBR format, the DB fields are included in ascending order based on the LCGi. For example, the DB in FIG. 7B is remaining PDU set delay budget 1, remaining PDU set delay budget 2, or remaining PDU set delay budget m. The DB in FIG. 7C is remaining PDU set delay budget 1.
(2) LCGi: e.g., LCG0 to LCG7 as shown in FIGS. 7B and 7C.
   a) For the long DBR format, this field indicates the presence of the DB field for the logical channel group i. The LCGi field set to 1 indicates that the DB field for the logical channel group i is reported. The LCGi field set to 0 indicates that the DB field for the logical channel group i is not reported.
   b) For the long truncated DBR format, this field indicates whether logical channel group i has a delay budget. The LCGi field set to 1 indicates that logical channel group i has a delay budget. The LCGi field set to 0 indicates that logical channel group i does not have a delay budget.

Optionally, the MAC sub-PDU in FIGS. 7B and 7C may further include a PDU set ID (e.g., a frame ID), which indicates the PDU set corresponding to the DB, e.g., “remaining PDU set delay budget 1+PDU set #i”, “remaining PDU set delay budget 2+PDU set #i”, or “remaining PDU set delay budget m+PDU set #i” as shown in FIG. 7B or FIG. 7C. For instance, the PDU set ID may be a PDU set SN or a code index.

The embodiments of FIG. 7D refer to two or more DBs for each LCG. FIG. 7D shows a MAC sub-PDU of the DBR format, which includes two delay budgets for one LCG in long DBR. Similar to FIG. 7A, the MAC sub-PDU in FIG. 7D includes a MAC subheader and a MAC CE including LCG ID and two DBs, e.g., remaining PDU set delay budget 1 and remaining PDU set delay budget 2. Optionally, the MAC sub-PDU in FIG. 7D may further include a PDU set ID corresponding to the DB, e.g., “remaining PDU set delay budget 1+PDU set #i” or “remaining PDU set delay budget 2+PDU set #i” as shown in FIG. 7D. Optionally, the number of the DB field for the LCG is indicated in the MAC subheader or in another field in the MAC CE payload.

In some embodiments of the subject application, a UE may report a DBR not cancelled to a network by at least one of the following operations.
(1) The UE prioritizes DBR (e.g., Regular DBR, Periodic DBR), in a higher order than ‘data from any Logical Channel, except data from UL-CCCH’ during the Logical Channel Prioritization procedure.
(2) If UL grant is not enough to include DBR (e.g., padding DBR) for all the LCGs, the UE may prioritize the delay budget report in a decreasing order of the highest logical channel priority in each of the LCG; and in case of the equal priority of some LCGs, the UE may prioritize the delay budget report in an increasing order of the delay budget.
(3) If UL grant is not enough to include all the DBR (e.g., padding DBR) for all the LCHs, the UE may prioritize the delay budget report in a decreasing order of the highest logical channel priority; and in case of the equal priority of some LCHs, the UE may prioritize the delay budget report in an increasing order of the delay budget.

In some embodiments, there may be following operations:

For Regular DBR and Periodic DBR, the MAC entity of the UE shall:

| 1> | if more than one LCG has data available for transmission and/or delay | |
|---|---|---|
| | budget report for transmission when the MAC PDU containing the DBR is | |
| | to be built: | |
| | 2> | report Long DBR for all LCGs which have data available for |
| | | transmission and/or a delay budget for transmission. |
| 1> | else: | |
| | 2> | report Short DBR. |

For Padding DBR, the MAC entity of the UE shall:

| 1> | if the number of padding bits is greater than or equal to the size of the Short | |
|---|---|---|
| | DBR plus its subheader but less than the size of the Long DBR plus its | |
| | subheader: | |
| | 2> | if more than one LCG has data available for transmission and/or delay |
| | | budget report for transmission when the DBR is to be built: |

| | |
|---|---|
| 3> | if the number of padding bits is equal to the size of the Short DBR |
| | plus its subheader: |

| | |
|---|---|
| 4> | report Short Truncated DBR of the LCG with the highest priority |
| | logical channel with data available for transmission and/or a delay |
| | budget for transmission, and in case of equal priority, may report |
| | the DBR of the LCG with the minimum delay budget. |

| | |
|---|---|
| 3> | else: |

| | |
|---|---|
| 4> | report long truncated DBR of the LCG(s) with the logical channels |
| | having data available for transmission and/or delay budget report |
| | for transmission following a decreasing order of the highest |
| | priority logical channel (with or without data available for |
| | transmission) in each of these LCG(s), and in case of equal |
| | priority, may in an increasing order of the delay budget in each of |
| | these LCGs, and in case of equal priority and in case of equal |
| | delay budget, may in an increasing order of LCG ID. |

| | |
|---|---|
| 2> | else: |

| | |
|---|---|
| 3> | report Short DBR. |

| 1> | else if the number of padding bits is greater than or equal to the size of the | |
|---|---|---|
| | Long DBR plus its subheader: | |
| | 2> | report Long DBR for all LCGs or LCH(s) which have data available for |
| | | transmission and/or a delay budget for transmission. |

In some embodiments, there may be following operations:

For Regular DBR and Periodic DBR, the MAC entity of the UE shall:

| 1> | if more than one LCH has data available for transmission and/or delay | |
|---|---|---|
| | budget for transmission when the MAC PDU containing the DBR is to | |
| | be built: | |
| | 2> | report Long DBR for all LCHs which have data available for |
| | | transmission and/or a delay budget for transmission. |
| 1> | else: | |
| | 2> | report Short DBR. |

For Padding DBR, the MAC entity of the UE shall:

| 1> | if the number of padding bits is greater than or equal to the size of the | |
|---|---|---|
| | Short DBR plus its subheader but smaller than the size of the Long DBR | |
| | plus its subheader: | |
| | 2> | if more than one LCH has data available for transmission and/or |
| | | delay budget for transmission when the DBR is to be built: |

| | |
|---|---|
| 3> | if the number of padding bits is equal to the size of the Short DBR |
| | plus its subheader: |

| | |
|---|---|
| 4> | report Short Truncated DBR of the LCH with the highest priority |
| | logical channel with data available for transmission and/or a delay |
| | budget for transmission, and in case of equal priority, may report |
| | the DBR of the LCH with the minimum delay budget. |

| | |
|---|---|
| 3> | else: |

| | |
|---|---|
| 4> | report long truncated DBR of the LCH(s) with the logical |
| | channels having data available for transmission and/or delay |
| | budget for transmission following a decreasing order of the |
| | highest priority logical channel (with or without data available for |
| | transmission) in each of these LCH(s), and in case of equal |
| | priority, may in an increasing order of the delay budget in each of |
| | these LCHs, and in case of equal priority and in case of equal |
| | delay budget, may in an increasing order LCH ID. |

| | |
|---|---|
| 2> | else: |

| | |
|---|---|
| 3> | report Short DBR. |

| 1> | else if the number of padding bits is greater than or equal to the size of | |
|---|---|---|
| | the Long DBR plus its subheader: | |
| | 2> | report Long DBR for all LCGs or LCH(s) which have data available |
| | | for transmission and/or a delay budget for transmission. |

In some embodiments of the subject application, a UE (the MAC entity or PDCP entity) determines the remaining delay budget (or left delay budget or available delay budget) corresponding to a PDU set according to “A) the delay budget configured by the network” and “B) the delay budget offset from the upper layer”. An upper layer of the UE may indicate the delay budget offset (e.g., +2 ms or −2 ms) when delivering a PDU set to the PDCP layer of the UE. For example, “−2 ms” indicates that the PDU set arrives 2 ms later than expected by AS layer, and “+2 ms” indicates the PDU set arrives 2 ms earlier than expected by the AS layer. The UE may determine the remaining delay budget by adding the delay budget offset to the delay budget configured by an RRC message, i.e., “the remaining delay budget=A)+B)”.

To synchronize the delay budget for transmission and a discard timer, the discard timer may also be adjusted correspondingly. For instance, the PDCP entity of the UE may add the delay budget offset to the SDU discard timer or PDU set discard timer configured by an RRC message before starting the discard timer corresponding to a PDU set or an SDU.

In some embodiments of the subject application, a UE may determine the remaining delay budget corresponding to a PDU set according to “A) the delay budget configured by the network”, “B) the delay budget offset from the upper layer”, and “C) the delay between first or last reception of a PDU belonging to a PDU set from upper layer and reference time”.

The reference time can be the timing when multiplexing the DBR related to the PDU set in a MAC PDU or the transmission timing of the DBR related to the PDU set.

For example, the UE may determine the remaining delay budget by adding a delay budget offset to a delay budget configured by an RRC message and by subtracting the delay between the first or last reception of a PDU belonging to a PDU set from upper layer and the reference time, i.e., “the remaining delay budget=A)+B)−C)”.

In some embodiments of the subject application, a network configures the discard timer to a UE (e.g., in operation 412 in FIG. 4), and the UE may use an information element (IE) of “a discard timer”, which may also be named as “a PDU set discard timer”. This IE indicates the value of the discard timer corresponding to a PDU set of a data radio bearer (DRB). For example, the PDCP entity of the UE may set a discard timer corresponding to a PDU set and start the timer upon first or last reception of a PDU belonging to the PDU set from an upper layer of the UE. The discard timer counts down. The UE may discard the PDU set upon an expiry of the discard timer.

In some embodiments of the subject application, a MAC CE priority between a DBR and a BSR may be defined as follows:
(1) A priority of a MAC CE of DBR, e.g., Regular DBR or Periodic DBR, which may be DBR with exception of DBR included for padding, is higher than a priority of a MAC CE for BSR, with exception of BSR included for padding; or
(2) Prioritization among the MAC CE of DBR, e.g., Regular DBR or Periodic DBR, which may be DBR with exception of DBR included for padding, and the MAC CE for BSR, with exception of BSR included for padding, is up to a UE's implementation, e.g., the same priority can be considered; or
(3) A priority of the MAC CE of DBR, e.g., Regular DBR or Periodic DBR, which may be DBR with exception of DBR included for padding, is lower than a priority of the MAC CE for BSR, with exception of BSR included for padding; or
(4) A priority of a MAC CE of padding DBR is higher than a priority of a MAC CE for padding BSR; or
(5) Prioritization among the MAC CE of padding DBR and the MAC CE for padding BSR is up to a UE's implementation, e.g., the same priority can be considered; or
(6) A priority of the MAC CE of padding DBR is lower than a priority of the MAC CE for padding BSR.

In some embodiments, there may be following operations:

Logical channels shall be prioritized in accordance with the following order (highest
priority listed first):

| | |
|---|---|
| - | C-RNTI MAC CE or data from UL-CCCH; |
| - | Configured Grant Confirmation MAC CE or MAC CEs for BFR or Multiple |
| | Entry Configured Grant Confirmation MAC CE; |
| - | Sidelink Configured Grant Confirmation MAC CE; |
| - | LBT failure MAC CE; |
| - | MAC CE for SL-BSR prioritized according to clause 5.22.1.6; |
| - | MAC CE for DBR, with exception of DBR included for padding; |
| - | MAC CE for DBR with exception of DBR included for padding, MAC CE for |
| | BSR, with exception of BSR included for padding; |
| - | MAC CE for DBR, with exception of DBR included for padding; |
| - | Single Entry PHR MAC CE or Multiple Entry PHR MAC CE; |
| - | MAC CE for the number of Desired Guard Symbols; |
| - | MAC CE for Pre-emptive BSR; |
| - | MAC CE for SL-BSR, with exception of SL-BSR prioritized according to clause |
| | 5.22.1.6 and SL-BSR included for padding; |
| - | data from any Logical Channel, except data from UL-CCCH; |
| - | MAC CE for Recommended bit rate query; |
| - | DBR included for padding; |
| - | DBR included for padding ,MAC CE for BSR included for padding; |
| - | DBR included for padding; |
| - | MAC CE for SL-BSR included for padding. |

In some embodiments of the subject application, a UE may determine the delay (i.e., a buffer delay value) corresponding to a PDU set according to at least the first or last PDU belonging to a PDU set with an LCH arriving at the AS layer (e.g., PDCP entity) and report the delay report (DR) corresponding to a PDU set to the network, in order to assist the network to determine the available or remaining or left delay budget corresponding to the PDU set for transmission when the network receives the DR from the UE. The DR may be included in a MAC CE, a PDCP control PDU, an RLC status report, or uplink physical control information, or may be included in Layer 2 header (e.g., the L2 header of the first arrival PDU of the PDU set or the L2 header of an enhanced BSR (EBSR) (for transmion of the first arrival PDU of the PDU set)).

In an embodiment, the network transmits DR configuration(s) to the UE in an RRC message (e.g., RRCReconfiguration), which is used to enable a DR corresponding to a PDU set. The DR configuration(s) may include at least one of:
(1) periodicDR-Timer: this IE indicates the value of the periodical DR timer of an LCH or an LCG or a MAC entity in the UE.
(2) retxDR-Timer: this IE indicates the value of the retransmission DR timer of an LCH or an LCG or a MAC entity in the UE.
(3) DR trigger threshold: this IE indicates a trigger threshold of an LCH or an LCG or a MAC entity in the UE for the DR.
(4) DR cancel threshold: this IE indicates a cancel threshold of an LCH or an LCG or a MAC entity in the UE for the DR.
(5) DR allowed report logical channel: this IE indicates the delay budget report to the network is allowed for the LCH or the LCG or the MAC entity in the UE or the UE.
(6) DR allowed report data radio bearer: this IE indicates the delay budget report to the network is allowed for the DR.

In some embodiments of the subject application, a UE may determine the delay (i.e., a delay value) corresponding to a PDU set of an LCH or an LCG in FIGS. 5A and 5B. For example, there may be following specific embodiments.

In an embodiment, a MAC entity of the UE may acquire T1 value from the PDCP layer of a DRB of the LCH. The MAC entity may acquire T2 or T3 from the PDCP layer of the LCH.
T1=Timing of first or last reception of a PDU belonging to a PDU set from an upper layer. The PDU may be an important PDU belonging to the PDU set.
T2=MAC PDU multiplexing timing of the DR related to the PDU set.
T3=Timing of the beginning or ending of the UL grant for transmitting the MAC CE of DR related to the PDU set or for transmitting the first arrival PDU of the PDU set or for transmitting the EBSR or BSR for transmission of (the first arrival PDU of) the PDU set.

In this embodiment, the delay value may be calculated as (T2−T1) or calculated as (T3−T1).

In a further embodiment, upon first or last reception of a PDU belonging to a PDU set from an upper layer of the UE, a PDCP entity of the UE may notify a MAC entity of the UE that the PDU set arrives at the AS and may further notify the corresponding PDU set information, e.g., PDU set ID. The MAC entity may set a delay timer corresponding to the PDU set to 0 and start the timer upon reception of the notification from the PDCP entity. The delay timer counts. Then, the MAC entity may determine the length value of the delay timer as the delay till reference time. The reference time can be the timing when multiplexing the DR related to the PDU set in a MAC PDU or the transmission timing of the DR related to the PDU set or for transmitting the first arrival PDU of the PDU set or for transmitting the BSR for transmission of (the first arrival PDU of) the PDU set.

In another embodiment, the PDCP entity of the UE may set a delay timer corresponding to a PDU set to 0 and start the delay timer upon first or last reception of a PDU belonging to the PDU set from an upper layer of the UE. The delay timer counts. A MAC entity of the UE may acquire the value of the timer from the PDCP layer of a DRB as the delay when multiplexing (or assembling) the DR in a MAC PDU. For example, the gap between the timing multiplexing (or assembling) the DR in a MAC PDU and beginning or ending of the UL grant for the MAC PDU transmission is ignored.

In some embodiments of the subject application, a UE may trigger a delay report (DR) with an LCH (with data available for transmission) configured for the DR if at least one of the conditions is met:
(1) When the first or last PDU belonging to a PDU set with an LCH arrives at the access stratum layer e.g., PDCP layer. In this case, the DR may be referred below to as “Regular DR”.
(2) When the first or last PDU belonging to a PDU set with important indication (e.g., key frame indicator or I-frame type indicator) from upper layer with an LCH arrives at the access stratum layer, e.g., PDCP layer. In this case, the DR may be referred below to as “Regular DR”.
(3) Upon an expiry of the retxDR-Timer. For example, the UE starts the retxDR-Timer after the DR transmission. For DR triggered by retxDR-Timer expiry, at least one of the logical channels (allowed to report the delay budget) which belong to an LCG contains UL data. In this case, the DR may be referred below to as “Regular DR”. The UE may consider that the logical channel that triggered the DR is the highest priority logical channel (with or without data available for transmission) at the time the DR is triggered.
(4) Upon an expiry of the periodicDR-Timer. For example, the UE starts the periodicDR-Timer after the DR transmission. In this case, the DR may be referred below to as “Periodic DR”.
(5) When the delay corresponding to a PDU set is greater than or equal to the trigger threshold configured by an RRC message. In this case, the DR may be referred below to as “Regular DR”.
(6) UL resources are allocated and number of padding bits is greater than or equal to the size of the DR MAC CE plus its MAC subheader, in which case the DR may be referred below to as “Padding DR”.
(7) Requested by upper layers to report DR for an LCH and for a direction (e.g., UL) to the network. In this case, the DR may be referred below to as “Regular DR”.
(8) UL data, for an LCH (allowed to report the delay), becomes available to the MAC entity. In this case, the DR may be referred below to as “Regular DR”.
   This UL data belongs to an LCH (allowed to report the delay) with a priority higher than a priority of any LCH (allowed to report the delay budget) containing available UL data; or
   None of the LCHs (allowed to report the delay) contains any available UL data.

In some embodiments of the subject application, a UE may cancel a DR if at least one of the conditions is met:
(1) The delay of a PDU set is greater than or equal to a cancel threshold.
(2) The discard timer corresponding to a PDU set or a SDU corresponding to a PDU within a PDU set expires, i.e., delay=a length of the discard timer.
(3) All DRs triggered prior to the MAC PDU assembling timing shall be cancelled when a MAC PDU is transmitted and this PDU includes a DR which contains PDU set delay status up to (and including) the last event that triggered a DR prior to assembling the MAC PDU timing.
(4) When the UL grant(s) can accommodate all pending data available corresponding to PDU set(s) for transmission but is not sufficient to additionally accommodate the (padding) DR MAC CE plus its MAC subheader.
(5) When the UL grant(s) can accommodate all pending data available corresponding to PDU set(s) for transmission, but the UL grant(s) is not sufficient to additionally accommodate the MAC CE of (padding) DR plus its MAC subheader, and if the DR triggered with the highest logical channel priority is less than or equal to a logical channel priority corresponding to all the pending data available for transmission.

Some embodiments of the subject application refer to a DR format design, e.g., similar to the DBR formats in FIGS. 6A-7D. A MAC PDU may contain at most one DR, even when multiple events have triggered a DR. A DR may be per an LCH or per an LCG.

In some embodiments, the DR per LCH includes one DR for each LCH, including for one LCH. A MAC sub-PDU may include following fields:
(1) Delay: this field indicates the delay corresponding to a PDU set (with the maximum buffer delay) for the LCH (with or without data available for transmission) after the MAC PDU has been built. The LCH may be with the highest logical channel priority in a MAC entity of the UE or in the UE. The PDU set may be with the maximum delay in a MAC entity of the UE or in the UE. The LCH may be with or without data available for transmission after the MAC PDU has been built. The data available for transmission definition can be referenced in 3GPP TS38.322 and TS38.323. The Delay may be:
   Code index, e.g., 1 present 2 ms, 2 present 2.5 ms, 3 present 3 ms; or
   Absolute value, e.g., 1 ms, 1.5 ms, 2 ms, 2.5 ms, or 3 ms. A ms represents a millisecond.
(2) LCID (LCH identification): this field identifies the group of LCH(s) whose delay is being reported.
(3) PDU set information, e.g., PDU set ID (optional): this field indicates the PDU set corresponding to the delay. The PDU set identification may be:
   PDU set Sequence Number (SN); or
   Code index, e.g., 0 present current PDU set being transmitted, 1 present next PDU set to be transmitted.

In some further embodiments, the DR per LCH includes one DR for each LCH within two or more LCHs having data available for transmission and/or having DR for transmission in long DR format. The DR per LCH includes one delay budget for each LCH within parts of all LCHs having data available for transmission and/or having DR for transmission in long truncated DR format in case that the UL grant is not enough to accommodate the DR for all LCHs. A MAC sub-PDU may include following fields:
(1) Delay: this field indicates the delay corresponding to a PDU set (with the maximum buffer delay) for the LCH (with or without data available for transmission) after the MAC PDU has been built. The PDU set may be with the maximum delay in a MAC entity of the UE or in the UE. The LCH may be with or without data available for transmission after the MAC PDU has been built. For the long DR format and the long truncated DR format, the Delay fields are included in ascending order based on the LCHi field.
(2) LCHi:
   For the long DR format, the LCHi field indicates the presence of the Delay field for the logical channel i. The LCHi field set to 1 indicates that the Delay field for the logical channel i is reported. The LCHi field set to 0 indicates that the Delay field for the logical channel i is not reported.
   For the long truncated DR format, the LCHi field indicates whether logical channel i has buffer delay for transmission. The LCHi field set to 1 indicates that logical channel i has buffer delay for transmission. The LCHi field set to 0 indicates that logical channel i does not have buffer delay.

In some other embodiments, the DR per LCH includes two or more DR fields for each LCH. For example, a MAC sub-PDU includes a MAC subheader and a MAC CE including LCID and two or more DR fields for each LCH, e.g., PDU set delay 1 and PDU set delay 2 and etc. Optionally, the MAC sub-PDU may further include a PDU set information corresponding to the DR fields, e.g., “PDU set delay 1+PDU set #i” or “PDU set delay 2+PDU set #i”. Optionally, the number of the DR for the LCH is indicated in the MAC subheader or in another field in the MAC CE payload.

In some embodiments, a DR per LCG may be one DR for one LCG, which includes following fields:
(1) Delay: this field indicates the delay corresponding to a PDU set (with the maximum buffer delay) with the LCH (with the highest priority logical channel) (with or without data available for transmission) in the LCG. The LCG may be with the highest logical channel priority in a MAC entity of the UE or in the UE. The LCH may be with the highest logical channel priority in an LCG. The PDU set may be with the maximum delay in a MAC entity of UE or in the UE. The LCG may be with or without data available for transmission after the MAC PDU has been built. The data available for transmission definition can be referenced in 3GPP TS38322 and TS38.323.
(2) LCG ID: this field identifies the group of logical channel(s) whose delay is being reported.

In some other embodiments, one DR for each LCG within all LCGs having data available for transmission and/or having DR for transmission in long DR format, or one DR for each LCG within parts of all LCGs having data available for transmission and/or having DR for transmission in long truncated DR format in case that the UL grant is not enough to accommodate the DR for all LCGs. DR may include following fields:
(1) Delay: this field indicates the delay corresponding to a PDU set (with the maximum buffer delay) for the LCH (with the highest priority logical channel) (with or without data available for transmission) in the LCG after the MAC PDU has been built. The LCH may be with the highest logical channel priority in an LCG. The PDU set may be with the maximum delay in a MAC entity of the UE or in the UE. The LCG may be with or without data available for transmission after the MAC PDU has been built. For the long DR format and the long truncated DR format, the Delay fields are included in an ascending order based on the LCGi field.
(2) LCGi:
   For the long DR format, the LCGi field indicates the presence of the Delay field for the logical channel group i. The LCGi field set to 1 indicates that the Delay field for the logical channel group i is reported. The LCGi field set to 0 indicates that the Delay field for the logical channel group i is not reported.
   For the long truncated DR format, the LCGi field indicates whether logical channel group i has delay. The LCGi field set to 1 indicates that logical channel group i has delay. The LCGi field set to 0 indicates that logical channel group i does not have delay.

In some embodiments of the subject application, there are two or more DRs for each LCG. For example, there are two DRs for one LCG in long DR format. Similar to FIG. 7A, a MAC sub-PDU includes a MAC subheader and a MAC CE including an LCG ID and two DRs, e.g., PDU set delay 1 and PDU set delay 2. The DR may further include a PDU set ID corresponding to the DB, e.g., “remaining PDU set delay 1+PDU set #i” or “remaining PDU set delay 2+PDU set #i”. Optionally, a total number of DR(s) field for an LCG is indicated in the MAC subheader or in another field in the MAC CE payload.

In some embodiments of the subject application, a UE may report a DR not cancelled to a network by at least one of the following operations.
(1) The UE prioritizes Regular DR (e.g., Regular DR, Periodic DR), in a higher order than ‘data from any Logical Channel during the Logical Channel, except data from UL-CCCH’ during the Logical Channel Prioritization procedure.
(2) If the UL grant is not enough to include DR (e.g., padding DR) for all LCGs, the UE may prioritize the delay report in a decreasing order of the highest logical channel priority in each of the LCG; and in case of the equal priority of some LCGs, the UE may prioritize the delay report in a decreasing order of the buffer delay.
(3) If UL grant is not enough to include DR (e.g., padding DR) for all the LCHs, the UE may prioritize the delay report in a decreasing order of the highest logical channel priority; and in case of the equal priority of some LCHs, the UE may prioritize the delay report in a decreasing order of the buffer delay.

In some embodiments, there may be following operations:

For Regular DR and Periodic DR, the MAC entity of the UE shall:

| 1> | if more than one LCG (or LCH) has data available for transmission and/or | |
|---|---|---|
| | delay for transmission when the MAC PDU containing the DR is to be built: | |
| | 2> | report Long DR for all LCGs (or LCHs) which have delay report for |
| | | transmission and/or a data available for transmission. |
| 1> | else: | |
| | 2> | report Short DR. |
| | | For Padding DR, the MAC entity shall: |
| 1> | if the number of padding bits is greater than or equal to the size of the Short | |
| | DR plus its subheader but less than the size of the Long DR plus its | |
| | subheader: | |
| | 2> | if more than one LCG (or LCH) has data available for transmission |
| | | and/or delay report for transmission when the DR is to be built: |

| | |
|---|---|
| 3> | if the number of padding bits is equal to the size of the Short DR plus |
| | its subheader: |

| | |
|---|---|
| 4> | report Short Truncated DR of the LCG (or LCH) with the highest |
| | priority logical channel with data available for transmission and/or |
| | a delay report for transmission, and in case of equal priority, may |
| | report the DR of the LCG (or LCH) with the maximum delay. |

| | |
|---|---|
| 3> | else: |

| | |
|---|---|
| 4> | report long truncated DR of the LCG(s) (or LCH(s)) with the logical |
| | channels having data available for transmission and/or delay report |
| | for transmission following a decreasing order of the highest priority |
| | logical channel (with or without data available for transmission) in |
| | each of these LCG(s) (or LCH(s)), and in case of equal priority, in a |
| | decreasing order of the delay in each of these LCGs(or LCHs), and |
| | in case of equal priority and in case of equal delay, in an increasing |
| | order of LCG ID (or LCH ID). |

| | |
|---|---|
| 2> | else: |

| | |
|---|---|
| 3> | report Short DR. |

| 1> | else if the number of padding bits is greater than or equal to the size of the | |
|---|---|---|
| | 2> | Long DR plus its subheader: |
| | | report Long DR for all LCGs (or LCH(s)) which have data available for |
| | | transmission and/or delay report for transmission. |

In some embodiments of the subject application, a UE (a MAC entity or a PDCP entity) determines the delay corresponding to a PDU set as “D) the delay offset from the upper layer of the UE”.
(1) Upper layer of the UE indicates the delay offset (e.g., +2 ms or −2 ms) when delivering a PDU set to the PDCP layer. For example, −2 ms indicates that the PDU set arrives 2 ms later than expected by the AS layer of the UE, and +2 ms indicates that the PDU set arrives 2 ms earlier than expected by the AS layer.
(2) PDCP entity of the UE may add the delay offset to a discard timer configured by an RRC message before starting the discard timer corresponding to the PDU set.

In some embodiments of the subject application, a UE determines the delay corresponding to a PDU set according to “D) the delay offset from the upper layer” and “C) the delay between the first or last reception of a PDU belonging to a PDU set from an upper layer of the UE and reference time”. The value of “C)” may be determined by any manner in the embodiments of FIGS. 5A and 5B, for example, “C)” may be equal to (T2−T1) or (T3−T1).

In these embodiments, the reference time can be the timing when multiplexing or assembling the DR related to the PDU set in a MAC PDU or the transmission timing of the DR related to the PDU set. For example, the UE may determine the delay corresponding to the PDU set by adding a delay offset to the delay between the first or last reception of a PDU belonging to the PDU set from the upper layer and the reference time, i.e., delay=D)+C).

In some embodiments of the subject application, a UE (a MAC entity or a PDCP entity) determines the delay corresponding to a PDU set as “C) the delay between the first or last reception of a PDU belonging to a PDU set from an upper layer of the UE and reference time”.

In some embodiments of the subject application, a MAC CE priority between a DR and a BSR may be defined:
(1) A priority of a MAC CE of DR, e.g., Regular DR or Periodic DR, which may be DR with exception of DR included for padding, is higher than a priority of a MAC CE for BSR, with exception of BSR included for padding; or
(2) Prioritization among the MAC CE of DR, e.g., Regular DR or Periodic DR, which may be DR with exception of DR included for padding, and the MAC CE for Regular BSR, with exception of BSR included for padding, is up to a UE's implementation, e.g., the same priority can be considered; or
(3) Priority of the MAC CE of DR, e.g., Regular DR or Periodic DR, which may be DR with exception of DR included for padding, is lower than a priority of the MAC CE for BSR, e.g., Regular DR or Periodic DR, which may be DR with exception of DR included for padding; or
(4) Priority of a MAC CE of Padding DR is higher than a priority of a MAC CE for Padding BSR; or
(5) Prioritization among the MAC CE of Padding DR and the MAC CE for Padding BSR is up to a UE's implementation, e.g., the same priority can be considered; or
(6) Priority of the MAC CE of Padding DR is lower than a priority of the MAC CE for Padding BSR.

In some other embodiments of the subject application, a UE may report the first timing (T1) of first or last reception of a PDU corresponding to a PDU set from the upper layer in an arrival timing report (ATR), instead of reporting the abovementioned remaining delay budget or the delay corresponding to the PDU set. In these embodiments, the order of the earliest T1 corresponding to a PDU set may be applied, instead of applying the decreasing order of the abovementioned remaining delay budget or the increasing order of the delay when needed, e.g., in case of prioritizing the report in case that the UL grant is not enough to accommodate all the (padding) reports or in case of selecting which one PDU set for the report triggering among more than one PDU set in one or more LCHs or LCGs. Based on T1 received from the UE, the network can determine the remaining delay budget for the PDU set based on T1. Optionally, T1 is the first timing corresponding to the PDU set with earliest arriving timing within the one or more PDU sets. Optionally, T1 is the first timing corresponding to one PDU set with a highest priority logical channel (in an LCG or in a MAC entity of the UE or in the UE) within the one or more PDU sets, and wherein the highest priority logical channel is allowed to report the first timing in an LCG or in a MAC entity of the UE or in the UE. Optionally, T1 is the first timing corresponding to one PDU set within the one or more PDU sets in an LCG or in an LCH with or without data available for transmission.

In some other embodiments of the subject application, a UE may report the delay information including the abovementioned first timing (T1) or remaining delay budget or buffer delay in an enhanced buffer status report (EBSR) (for transmion of the first arrival PDU of the PDU set), instead of transmitting an ATR, a DBR or a DR.

In some embodiments of the subject application, a periodicEBSR-Timer associated with an EBSR may be configured by a network independently of the periodicBSR-Timer of legacy BSR in TS 38.321; or a retxEBSR-Timer associated with the EBSR may be configured by the network independently of the retxBSR-Timer of legacy BSR in TS 38.321. A UE may start the periodicEBSR-Timer and/or retxEBSR-Timer after transmission of the EBSR. Optionally, the periodicEBSR-Timer and/or retxEBSR-Timer may be separately configured per LCH or LCG or MAC entity of the UE or the UE.

In some embodiments of the subject application, trigger condition(s) of an EBSR and/or cancel condition(s) of the EBSR may be the same as or similar to the trigger condition(s) and/or cancel condition(s) for DBR or DR or ATR as disclosed above in the present application. When the EBSR is triggered for one LCG or LCH, a UE may determine the delay information and a buffer size for the LCG or LCH and include both of them in the EBSR for the LCG or LCH.

In some embodiments of the subject application, the configuration(s) for an EBSR may be the same as or similar to the configuration related to the delay information which is determined in operation 201 as disclosed above in the embodiments of FIG. 2.

In some embodiments of the subject application, if an EBSR is configured for a UE or a MAC entity of the UE or an LCG or an LCH by a network, the UE only use the EBSR for transmission, even if only legacy BSR is triggered for some LCGs or LCHs. In this case, the EBSR may indicate whether the delay information for one LCG or one LCH is presented in the EBSR. An LCID may be allocated to identify the EBSR format.

In some embodiments of the subject application, if there is an EBSR triggered for an LCG or an LCH, a UE only use the EBSR for transmission, even if the legacy BSR is triggered for some other LCGs or LCHs. In this case, the EBSR may include both the delay information and the buffer size for the LCG or LCH. The EBSR may only include the buffer size without the delay information for the other LCGs or LCHs.

In some embodiments of the subject application, if an EBSR is configured for the UE or a MAC entity of the UE or an LCG or an LCH by the network, the UE may only use a BSR for transmission, if only legacy BSR is triggered for some LCGs or LCHs but the EBSR is not triggered.

In some embodiments of the subject application, both legacy BSR and an EBSR are allowed to be triggered and separately transmitted in different MAC sub-PDUs. In these embodiments, a UE may perform a prioritization procedure for an EBSR and a BSR. In some embodiments, a MAC CE priority between an EBSR and a BSR may be defined as follows:
(1) A priority of a MAC CE of EBSR, e.g., Regular EBSR or Periodic EBSR, which may be EBSR with exception of EBSR included for padding, is higher than a priority of a MAC CE for BSR, with exception of BSR included for padding; or
(2) Prioritization among the MAC CE of EBSR, e.g., Regular EBSR or Periodic EBSR, which may be EBSR with exception of EBSR included for padding, and the MAC CE for BSR, with exception of BSR included for padding, is up to a UE's implementation, e.g., the same priority can be considered; or
(3) A priority of the MAC CE of EBSR, e.g., Regular EBSR or Periodic EBSR, which may be EBSR with exception of EBSR included for padding, is lower than a priority of the MAC CE for BSR, with exception of BSR included for padding; or
(4) A priority of a MAC CE of padding EBSR is higher than a priority of a MAC CE for padding BSR; or
(5) Prioritization among the MAC CE of padding EBSR and the MAC CE for padding BSR is up to a UE's implementation, e.g., the same priority can be considered; or
(6) A priority of the MAC CE of padding EBSR is lower than a priority of the MAC CE for padding BSR.

In some embodiments of the subject application, a UE may report an EBSR, that is not cancelled, to a network by at least one of the following operations. These operations are similar to the operations for DBR or DR as disclosed above in the present application. The definitions of Regular EBSR, Periodic EBSR, or Padding EBSR are similar to definitions of Regular DBR, Periodic DBR, or Padding DBR as disclosed above in the present application.
(1) The UE prioritizes Regular EBSR (e.g., Regular EBSR, Periodic EBSR), in a higher order than ‘data from any Logical Channel during the Logical Channel, except data from UL-CCCH’ during the logical channel prioritization procedure.
(2) If the UL grant is not enough to include an EBSR (e.g., Padding EBSR) for all LCGs, the UE may prioritize the EBSR in a decreasing order of the highest logical channel priority in each of the LCGs; and in case of the equal priority of some LCGs, the UE may prioritize the EBSR in a decreasing order of the delay or in an increasing order of the delay budget or in an increasing order of the first timing (i.e., T1 as disclosed above in the present application).
(3) If UL grant is not enough to include EBSR (e.g., Padding EBSR) for all the LCHs, the UE may prioritize the EBSR in a decreasing order of the highest logical channel priority; and in case of the equal priority of some LCHs, the UE may prioritize the EBSR in a decreasing order of the delay or in an increasing order of the delay budget or in an increasing order of the first timing (T1).

In some embodiments, there may be following operations:

For Regular EBSR and Periodic EBSR, the MAC entity of the UE shall:

| 1> | if more than one LCG (or LCH) has data available for transmission and/or | |
|---|---|---|
| | delay information for transmission when the MAC PDU containing the | |
| | EBSR is to be built: | |
| | 2> | report Long EBSR for all LCGs (or LCHs) which have delay information |
| | | for transmission and/or data available for transmission. |
| 1> | else: | |
| | 2> | report Short EBSR. |
| | | For Padding EBSR, the MAC entity shall: |
| 1> | if the number of padding bits is greater than or equal to the size of the Short | |
| | EBSR plus its subheader but less than the size of the Long EBSR plus its | |
| | subheader: | |
| | 2> | if more than one LCG (or LCH) has data available for transmission |
| | | and/or delay informaiton for transmission when the EBSR is to be built: |

| | |
|---|---|
| 3> | if the number of padding bits is equal to the size of the Short EBSR |
| | plus its subheader: |

| | |
|---|---|
| 4> | report Short Truncated EBSR of the LCG (or LCH) with the highest |
| | priority logical channel with delay information for transmission |
| | and/or data available for transmission, and in case of equal |
| | priority, may report the EBSR of the LCG (or LCH) with the |
| | minimum delay budget or with the maximum delay or with the |
| | earliest first timing. |

| | |
|---|---|
| 3> | else: |

| | |
|---|---|
| 4> | report long truncated EBSR format of the LCG(s) (or LCH(s)) with |
| | the logical channels having data available for transmission and/or |
| | delay information for transmission following a decreasing order of |
| | the highest priority logical channel (with or without data available |
| | for transmission) in each of these LCG(s) (or LCH(s)), and in case |
| | of equal priority, in a decreasing order of the delay or in an |
| | increasing order of the delay buget or in an increasing order of the |
| | first timing in each of these LCGs( or LCHs), and in case of equal |
| | priority, and in case of equal delay or delay budget or first timing, in |
| | an increasing order of LCG ID (or LCH ID). |

| | |
|---|---|
| 2> | else: |

| | |
|---|---|
| 3> | report Short EBSR. |

| 1> | else if the number of padding bits is greater than or equal to the size of the | |
|---|---|---|
| | Long EBSR plus its subheader: | |
| | 2> | report Long EBSR for all LCGs (or LCH(s)) which have delay |
| | | information for transmission and/or data available for transmission. |

It should be appreciated by persons skilled in the art that all other details described in all other embodiments of the subject application (for example, trigger condition(s), cancel condition(s), configuration(s) and/or operations related to an ATR, a DBR or a DR) are applicable for the embodiments regarding an EBSR (for example, trigger condition(s), cancel condition(s), and/or operations related to an EBSR). Moreover, the trigger condition(s), cancel condition(s), configuration(s), and/or operations related to an EBSR may be eliminated or modified, without departing from the spirit and scope of the disclosure.

FIG. 8 illustrates an exemplary block diagram of an apparatus 800 for a data discarding operation in accordance with some embodiments of the subject application. As shown in FIG. 8, the apparatus 800 may include at least one non-transitory computer-readable medium 802, at least one receiving circuitry 804, at least one transmitting circuitry 806, and at least one processor 808 coupled to the non-transitory computer-readable medium 802, the receiving circuitry 804 and the transmitting circuitry 806. The at least one processor 808 may be a CPU, a DSP, a microprocessor etc. The apparatus 800 may be a network node (e.g., a BS) or a UE configured to perform a method illustrated in the above or the like.

Although in this figure, elements such as the at least one processor 808, receiving circuitry 804, and transmitting circuitry 806 are described in the singular, the plural is contemplated unless a limitation to the singular is explicitly stated. In some embodiments of the subject application, the receiving circuitry 804 and the transmitting circuitry 806 can be combined into a single device, such as a transceiver. In certain embodiments of the subject application, the apparatus 800 may further include an input device, a memory, and/or other components.

In some embodiments of the subject application, the non-transitory computer-readable medium 802 may have stored thereon computer-executable instructions to cause a processor to implement the methods with respect to a UE or a network node (e.g., a BS) as described or illustrated above. For example, the computer-executable instructions, when executed, cause the processor 808 interacting with receiving circuitry 804 and transmitting circuitry 806, so as to perform the steps with respect to a UE or a network node (e.g., a BS) as described or illustrated above.

FIG. 9 illustrates a further exemplary block diagram of an apparatus 900 for a data discarding operation in accordance with some embodiments of the subject application. Referring to FIG. 9, the apparatus 900, for example a BS or a UE, may include at least one processor 902 and at least one transceiver 904 coupled to the at least one processor 902. The transceiver 904 may include at least one separate receiving circuitry 906 and transmitting circuitry 908, or at least one integrated receiving circuitry 906 and transmitting circuitry 908. The at least one processor 902 may be a CPU, a DSP, a microprocessor etc.

According to some other embodiments of the subject application, when the apparatus 900 is a UE, the processor 902 may be configured to: determine delay information associated with one or more protocol data unit (PDU) sets received from an upper layer of the UE, wherein the delay information includes at least one of: a remaining PDU set delay budget; a PDU set buffer delay; a PDU set delay budget offset; or first timing when receiving a PDU within the one or more PDU sets from the upper layer; and transmit a report including the delay information, wherein the report is at least one of: a delay budget report (DBR); a delay report (DR); an arriving timing report (ATR); or an enhanced buffer status report (EBSR).

According to some embodiments of the subject application, when the apparatus 900 is a network node (e.g., a BS), the processor 902 is configured to: transmit a configuration related to delay information associated with one or more protocol data unit (PDU) sets received from an upper layer of a user equipment (UE) via the transceiver 904 to the UE; and receive a report including the delay information via the transceiver 904 from the UE.

The method(s) of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While this disclosure has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, those having ordinary skills in the art would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including”. Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the subject application, but is not used to limit the substance of the subject application.

What is claimed is:

1-15. (canceled)

16. A user equipment (UE) for wireless communication, comprising:
at least one memory; and
at least one processor coupled with the at least one memory and configured to cause the UE to:
receive delay status report configuration;
receive one or more protocol data unit (PDU) sets from an upper layer of the UE; and
transmit, based at least in part on the delay status report configuration, a delay status report comprising delay information associated with the one or more PDU sets.

17. The UE of claim 16, wherein the delay information comprises a remaining PDU set delay budget.

18. The UE of claim 17, wherein the remaining PDU set delay budget corresponds to a PDU set with a minimum delay budget within the one or more PDU sets.

19. The UE of claim 16, wherein the delay status report comprises a delay budget report (DBR) or an enhanced buffer status report (EBSR) included in a medium access control (MAC) control element (CE).

20. The UE of claim 16, wherein the delay information comprises delay information corresponding to a PDU set within the one or more PDU sets in a logical channel group (LCG) with or without data available for transmission.

21. The UE of claim 16, wherein the delay information is determined based at least in part on at least one of:
a service data unit (SDU) discard timer;
a reference time associated with the one or more PDU sets; or
a first timing associated with receiving a PDU of the one or more PDU sets.

22. The UE of claim 21, wherein the one or more PDU sets are received by an access stratum (AS) layer of the UE, and wherein the first timing comprises an arrive timing at the AS layer of a first arrival PDU of the one or more PDU sets from the upper layer.

23. The UE of claim 21, wherein the reference time comprises a timing associated with transmitting the delay status report.

24. The UE of claim 16, wherein the at least one processor is configured to cause the UE to:
receive delay configuration information associated with the delay information, wherein the delay configuration information comprises at least one of information for enabling a transmission of the delay status report, a trigger threshold associated with a trigger condition for the delay status report, or a length of a service data unit (SDU) discard timer.

25. The UE of claim 24, wherein the delay configuration information is associated with a logical channel group (LCG) permitted to report the delay information.

26. The UE of claim 16, wherein a priority of a first medium access control (MAC) control element (CE) of the delay status report is greater than or equal to a priority of a second MAC CE for a first type of a buffer status report (BSR).

27. The UE of claim 16, wherein the at least one processor is configured to cause the UE to:
trigger a delay budget report (DBR) or an enhanced buffer status report (EBSR) with a logical channel (LCH) upon a PDU set delay budget being less than a first trigger threshold associated with a trigger condition for the delay status report.

28. The UE of claim 16, wherein the at least one processor is configured to cause the UE to:
cancel the delay status report, and wherein a cancel condition comprises at least one of:
a discard timer corresponding to a service data unit (SDU) of a PDU within a PDU set expires;
a remaining delay budget corresponding to a PDU within a PDU set equals 0;
a remaining PDU set delay budget is less than or equal to a cancel threshold;
transmitting a medium access control (MAC) PDU including the delay status report, wherein the delay status report is triggered prior to assembling the MAC PDU or at timing of assembling the MAC PDU; or
padding bits of allocated uplink resources are sufficient to accommodate a MAC PDU without the delay status report and not sufficient to accommodate a MAC PDU with the delay status report.

29. The UE of claim 16, wherein one or more of:
a logical channel group (LCG) field in the report indicates a delay budget (DB) field for a LCG;
the LCG field set to 1 indicates that a delay budget field for the LCG is reported; or
the LCG field set to 0 indicates that the DB field for the LCG is not reported.

30. The UE of claim 16, wherein:
a medium access control (MAC) PDU comprises a maximum of one delay budget report (DBR) or a maximum of one enhanced buffer status report (EBSR); and
the at least one processor is configured to cause the UE to report DBR for all logical channel groups (LCGs) which have data available for transmission and a delay information for transmission when the MAC PDU containing the DBR or the EBSR is to be generated.

31. The UE of claim 30, wherein the at least one processor is configured to cause the UE to:
determine a delay information and a buffer size for a LCG when the EBSR is triggered for the LCG; and
include both the delay information and the buffer size for the LCG or a LCH in the EBSR for the LCG.

32. The UE of claim 30, wherein both a buffer status report (BSR) and the EBSR are permitted to be triggered and separately transmitted in different MAC sub-PDUs.

33. A processor for wireless communication, comprising:
at least one controller coupled with at least one memory and configured to cause the processor to:
receive delay status report configuration;
receive one or more protocol data unit (PDU) sets from an upper layer of a user equipment (UE); and
transmit, based at least in part on the delay status report configuration, a delay status report comprising delay information associated with the one or more PDU sets.

34. A method performed by a user equipment (UE), comprising:
receiving delay status report configuration;
receiving one or more protocol data unit (PDU) sets from an upper layer of the UE; and
transmitting, based at least in part on the delay status report configuration, a delay status report comprising delay information associated with the one or more PDU sets.

35. A network node for wireless communication, comprising:
at least one memory; and
at least one processor coupled with the at least one memory and configured to cause the network node to:
transmit delay status report configuration associated with one or more protocol data unit (PDU) sets of an upper layer of a user equipment (UE); and
receive, based at least in part on the delay status report configuration, a delay status report comprising delay information associated with the one or more PDU sets.
